(19) United States
(12) Patent Application Publication
(10) Pub. No.: US 2025/0126625 A1
(43) Pub. Date: Apr. 17, 2025

(54) MULTI-BIT SIDELINK FEEDBACK

(71) Applicant: QUALCOMM Incorporated, San Diego, CA (US)

(72) Inventors: Chih-Hao LIU, San Diego, CA (US); Jing SUN, San Diego, CA (US); Yisheng XUE, San Diego, CA (US); Shaozhen GUO, Beijing (CN); Xiaoxia ZHANG, San Diego, CA (US)

(21) Appl. No.: 18/728,778

(22) PCT Filed: Mar. 26, 2022
(86) PCT No.: PCT/CN2022/083212

§ 371 Date: Jul. 12, 2024

(51) Int. Cl. H04W 72/25; H04L 5/00; H04W 72/044

(52) U.S. Cl. CPC H04W 72/25; H04L 5/0055; H04W 72/044

(57) ABSTRACT

Certain aspects of the present disclosure provide techniques for type-1 hybrid automatic repeat request (HARQ) codebook usage and hashing for multi-bit sidelink feedback. Certain aspects provide a method for wireless communication by a first user equipment (UE). The method generally includes receiving, from a second UE, one or more sidelink data messages over a first subchannel during a time period having a duration of a first number of slots that is greater than one and transmitting, to the second UE, over a plurality of resource blocks of a sidelink feedback channel resource of a first feedback channel occasion of a set of periodically occurring feedback channel occasions, a first feedback message associated with the one or more sidelink data messages, wherein the first feedback message indicates a plurality of feedback bits comprising one or more feedback bits associated with the one or more sidelink data messages.

### BACKGROUND

### Field of the Disclosure

Aspects of the present disclosure relate to wireless communications, and more particularly, to techniques for multi-bit sidelink feedback.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communication by a first user equipment (UE), including receiving, from a second UE, one or more sidelink data messages over a first subchannel during a time period having a duration of a first number of slots that is greater than one and transmitting, to the second UE, over a plurality of resource blocks of a sidelink feedback channel resource of a first feedback channel occasion of a set of periodically occurring feedback channel occasions, a first feedback message associated with the one or more sidelink data messages, wherein the first feedback message indicates a plurality of feedback bits comprising one or more feedback bits associated with the one or more sidelink data messages, wherein the plurality of feedback bits further comprises a feedback bit that is not associated with any sidelink data message, and wherein the plurality of feedback bits comprises at least one feedback bit for each slot of the time period.

One aspect provides a method for wireless communication by a first UE, including transmitting, to a second UE, one or more sidelink data messages over a first subchannel during a time period having a duration of a first number of slots that is greater than one and receiving, from the second UE, over a plurality of resource blocks of a sidelink feedback channel resource of a first feedback channel occasion of a set of periodically occurring feedback channel occasions, a first feedback message associated with the one or more sidelink data messages, wherein the first feedback message indicates a plurality of feedback bits comprising one or more feedback bits associated with the one or more sidelink data messages, wherein the plurality of feedback bits further comprises a feedback bit that is not associated with any sidelink data message, and wherein the plurality of feedback bits comprises at least one feedback bit for each slot of the time period.

One aspect provides a method for wireless communication by a first UE, including receiving, from a second UE, one or more sidelink data messages over a first subchannel or a first frequency interlace during a time period having a duration of a first number of slots that is greater than one; selecting a first sidelink feedback channel resource from a first plurality of sidelink feedback channel resources in a first resource pool based on at least one of a first identifier associated with the second UE or a groupcast identifier associated with the one or more sidelink data messages; and transmitting, to the second UE, over a plurality of resource blocks of the first sidelink feedback channel resource, a first feedback message associated with the one or more sidelink data messages, wherein the first feedback message indicates a plurality of feedback bits comprising one or more feedback bits associated with at least one of the one or more sidelink data messages.

One aspect provides a method for wireless communication by a first UE, including transmitting, to a second UE, one or more sidelink data messages over a first subchannel or a first frequency interlace during a time period having a duration of a first number of slots that is greater than one and receiving, from the second UE, over a plurality of resource blocks of a first sidelink feedback channel resource of a first plurality of sidelink feedback channel resources in a first resource pool, wherein the first sidelink feedback channel resource is associated with at least one of a first identifier associated with the first UE or a groupcast identifier associated with the one or more sidelink data messages, a first feedback message associated with the one or more sidelink data messages, wherein the first feedback message indicates a plurality of feedback bits comprising one or more feedback bits associated with at least one of the one or more sidelink data messages.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform any one or more of the aforementioned methods and/or those described elsewhere herein; a computer program product embodied on a computer-readable storage medium comprising code for performing any one or more of the aforementioned methods and/or those described elsewhere herein; and/or an apparatus comprising means for performing any one or more of the aforementioned methods and/or those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts an example signaling diagram that supports multi-bit feedback via a sidelink feedback channel.

FIG. 6 depicts example physical sidelink feedback channel (PSFCH) multiplexing schemes that support multi-bit feedback via a sidelink feedback channel.

FIG. 7 illustrates an interlaced PSFCH transmission.

FIG. 8 is a call flow diagram illustrating example sidelink signaling for providing multi-bit feedback for multiple PSSCH occasions occurring over multiple time periods in a single PSFCH resource.

FIG. 9 illustrates an example resource mapping that supports techniques for type-1 hybrid automatic repeat request (HARQ) codebook PSFCH transmission for a fixed HARQ timeline.

FIG. 10 illustrates an example resource mapping that supports techniques for type-1 HARQ codebook PSFCH transmission for a dynamic HARQ timeline.

FIG. 11 is a call flow diagram illustrating example sidelink signaling for providing multi-bit feedback for multiple PSSCH occasions occurring over multiple time periods in a single PSFCH resource.

FIG. 12 illustrates a single-bit PSFCH resource pool frequency division multiplexed (FDMed) with a multi-bit PSFCH resource pool.

FIG. 13 illustrates a single-bit PSFCH resource pool time division multiplexed (TDMed) with a multi-bit PSFCH resource pool.

FIG. 14 depicts a method for wireless communications.

FIG. 15 depicts a method for wireless communications.

FIG. 16 depicts a method for wireless communications.

FIG. 17 depicts a method for wireless communications.

FIG. 18 depicts aspects of an example communications device.

### DETAILED DESCRIPTION

Aspects of the present disclosure provide apparatuses, methods, processing systems, and computer-readable mediums for providing multi-bit feedback for multiple sidelink data occasions occurring over multiple time periods in a single sidelink feedback channel resource. For example, certain aspects provide techniques for providing multi-bit feedback for multiple physical sidelink shared channel (PSSCH) occasions occurring over multiple slots in a single physical sidelink feedback channel (PSFCH) resource (e.g., of a single slot). Though certain aspects are described with respect to PSSCH occasions (e.g., each corresponding to a subchannel and/or spatial layer within a slot), the techniques herein may be applied to other suitable sidelink data occasions (e.g., physical sidelink control channel (PSCCH) occasions). Further, though certain aspects are described with respect to slots, the techniques herein may be applied to other suitable time periods. Further, though certain aspects are described with respect to PSFCH resources, the techniques herein may be applied to other suitable sidelink feedback channel resources.

In certain aspects, wireless communications devices in a wireless communications system are configured to provide feedback (e.g., hybrid automatic repeat request (HARQ) acknowledgement/negative acknowledgment (ACK/NACK) feedback) regarding whether a sidelink data message was successfully received and decoded or not. For example, a receiving user equipment (UE) may be scheduled (e.g., by a transmitting UE) to receive a sidelink data message from the transmitting UE on a PSSCH occasion occurring in a slot. In certain aspects, the receiving UE is scheduled by receiving, such as from the transmitting UE, control information (e.g., sidelink control information (SCI)) in a control channel (e.g., a physical sidelink control channel (PSCCH)) scheduling the sidelink data message.

The receiving UE may be configured to transmit, to the transmitting UE, feedback regarding whether the scheduled sidelink data message was successfully received and decoded or not. For example, the receiving UE may be configured to transmit an ACK when the scheduled sidelink data message is successfully received and decoded, and not transmit any feedback when the scheduled sidelink data message is not successfully received and decoded. As another example, the receiving UE may be configured to transmit a NACK when the scheduled sidelink data message is not successfully received and decoded, and not transmit any feedback when the scheduled sidelink data message is successfully received and decoded. As yet another example, the receiving UE may be configured to transmit an ACK when the scheduled sidelink data message is successfully received and decoded, and transmit a NACK when the scheduled sidelink data message is not successfully received and decoded. Though certain aspects are discussed with respect to HARQ feedback, the techniques herein may be applied to other suitable feedback types.

In certain aspects, the receiving UE may be scheduled to receive one or more sidelink data messages from a transmitting UE during a time period spanning multiple slots, wherein each slot includes at least one PSSCH occasion. Accordingly, the receiving UE may be configured to provide feedback for multiple PSSCH occasions spanning multiple slots. In some cases, however, the receiving UE may be unable to transmit feedback for more than one PSSCH occasion (e.g., unable to transmit more than one ACK or NACK, corresponding to one bit) per PSFCH resource. Thus, if the receiving UE needs to provide feedback for multiple PSSCH occasions to the transmitting UE, the receiving UE may transmit feedback for each PSSCH occasion in a different PSFCH resource. For example, the receiving UE may transmit first feedback for a first sidelink message, scheduled on a first PSSCH occasion, on a first PSFCH resource, and may transmit second feedback for a second sidelink message, scheduled on a second PSSCH occasion, on a second PSFCH resource. Transmitting feedback for one PSSCH occasion per PSFCH resource may result in higher signaling overhead and greater power consumption at the receiving UE. Moreover, transmitting feedback for one PSSCH occasion per PSFCH resource may result in greater sidelink feedback reporting latency (e.g., if there is a delay between the first PSFCH resource and the second PSFCH resource) and lower attainable throughput.

Accordingly, certain aspects herein provide techniques for providing feedback for multiple PSSCH occasions, occurring over multiple slots and corresponding to one or more sidelink data messages, in a single PSFCH resource. This may reduce signaling overhead and power consumption at the receiving UE, and further reduce sidelink feedback reporting latency. In particular, the techniques described herein may improve the latency and signaling efficiency of sidelink feedback reporting.

In certain aspects, the feedback for multiple PSSCH occasions, occurring over multiple slots and corresponding to one or more sidelink data messages, may be reported as a codebook (e.g., a HARQ codebook) in a single PSFCH resource. For example, the receiving UE may be configured with a time period (e.g., a HARQ timeline), having a duration of a number of slots greater than one (i.e., multiple slots) for which the receiving UE provides a codebook as feedback to the transmitting UE. A HARQ codebook may be a sequence of bits constructed using ACK/NACK feedback for the multiple PSSCH occasions occurring during the time period.

Certain aspects herein provide a type-1 HARQ codebook for providing multi-bit feedback in a single PSFCH resource. For a type-1 HARQ codebook, the size of the codebook may be fixed to the number of PSSCH occasions that occur during the time period, irrespective of the number of PSSCH occasions within the time period that the receiving UE is scheduled to receive sidelink data messages from the transmitting UE. For example, the time period may span four slots 0-3. The receiving UE may be scheduled to receive a sidelink data message on each of slots 0, 1 and 3. The multi-bit feedback for the time period, accordingly, may include a corresponding ACK/NACK bit for each of slots 0, 1, and 3 indicating whether the corresponding scheduled sidelink data message was successfully received and decoded or not. The multi-bit feedback for the time period may also include a NACK bit for slot 2 as padding, despite the receiving UE not being scheduled to receive any sidelink data message from the transmitting UE in slot 2, in order to keep the fixed size of the codebook. The bits of the multi-bit feedback may be used to generate a type-1 HARQ codebook (e.g., according to a codebook generation algorithm or mapping), indicating the plurality of feedback bits of the multi-bit feedback. The receiving UE may transmit the codebook in the single PSFCH resource. In certain aspects, other types of HARQ codebooks may be used, such as type 2 or type 3.

In certain aspects, there may be a plurality of PSFCH resources arranged in one or more resource pools. Further, in certain aspects, each PSFCH resource may include a plurality of frequency resources (e.g., a plurality of resources blocks, which in certain aspects are grouped into a plurality of frequency interlaces). Accordingly, certain aspects herein provide techniques for mapping (e.g., hashing) multi-bit feedback/PSSCH occasions to a particular PSFCH resource and/or particular frequency resources in a PSFCH resource. Such mapping techniques help avoid collisions in feedback reporting, for example, such as avoiding different receiving UEs transmitting different feedback in the same resources. For example, such mapping may be based on at least one of an identifier associated with the transmitting UE or a groupcast identifier (e.g., of a group including the receiving UE) associated with the one or more sidelink data messages.

Further, certain aspects provide techniques for providing multi-bit feedback for PSSCH occasions associated with different casting types (e.g., unicast, groupcast, broadcast). For example, certain aspects provide for use of the same resource pool for selecting PSFCH resources for PSSCH occasions associated with different casting types. Certain aspects provide for use of different resource pools for selecting PSFCH resources for PSSCH occasions associated with different casting types. Certain aspects provide for use of single PSSCH occasion feedback reporting in a single PSFCH resource for groupcast/broadcast, and multiple PSSCH occasion feedback reporting in a single PSFCH resource for unicast. Accordingly, techniques herein allow for feedback reporting of different casting types to co-exist, allowing flexibility in the types of sidelink communications that can occur while using multi-bit feedback in a single PSFCH resource.

Particular implementations of the subject matter described in this disclosure can be implemented to realize one or more of the following potential advantages. For example, a receiving device may attempt to provide multi-bit feedback in various deployment scenarios and, in accordance with the implementations described herein, may achieve greater performance in any of such various deployment scenarios. In some scenarios, for example, a system may support an extension of various protocol types (such as an enhanced mobile broadband (eMBB) protocol type) or carrier aggregation to sidelink, and a receiving wireless device may likely receive a continuous stream of sidelink data transmissions (such that the receiving wireless device may receive multiple sidelink data transmissions between PSFCH occasions) or may otherwise attempt to convey more feedback information (such as an ACK/NACK bit for each of multiple carriers) in a given PSFCH occasion. Additionally, or alternatively, in some scenarios, a receiving device may support sidelink communication over an unlicensed band. In such scenarios, the receiving device may be scheduled with relatively few or sparse PSFCH occasions (such as sparser than a spacing of four slots between PSFCH occasions), which also may result in the receiving device receiving multiple sidelink data transmissions between PSFCH opportunities. In any of such scenarios, instead of using (such as using frequency division multiplexing (FDMing)) multiple PSFCH resources to convey multiple feedback bits, the receiving device may convey multi-bit feedback on a single PSFCH resource, which may reduce a quantity of PSFCH resources used at a same time (by a same receiving device). As such, a receiving device may provide more complete feedback or may provide feedback with lower latency without hindering a multiplexing capability of the system. Further, and as a result of more complete or lower latency feedback and maintained or greater multiplexing capability, the receiving device and the system may experience greater reliability and lower signaling overhead, and the receiving device may experience reduced power consumption. As such, the receiving device and the system may experience higher data rates, greater spectral efficiency, and greater system capacity, among other benefits.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

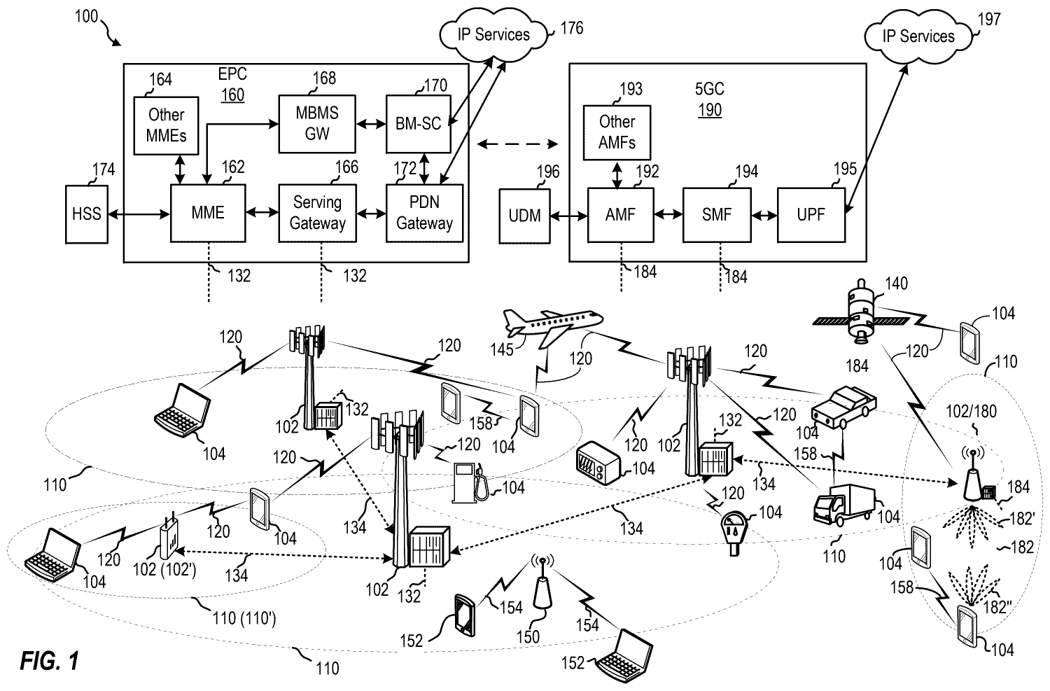

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

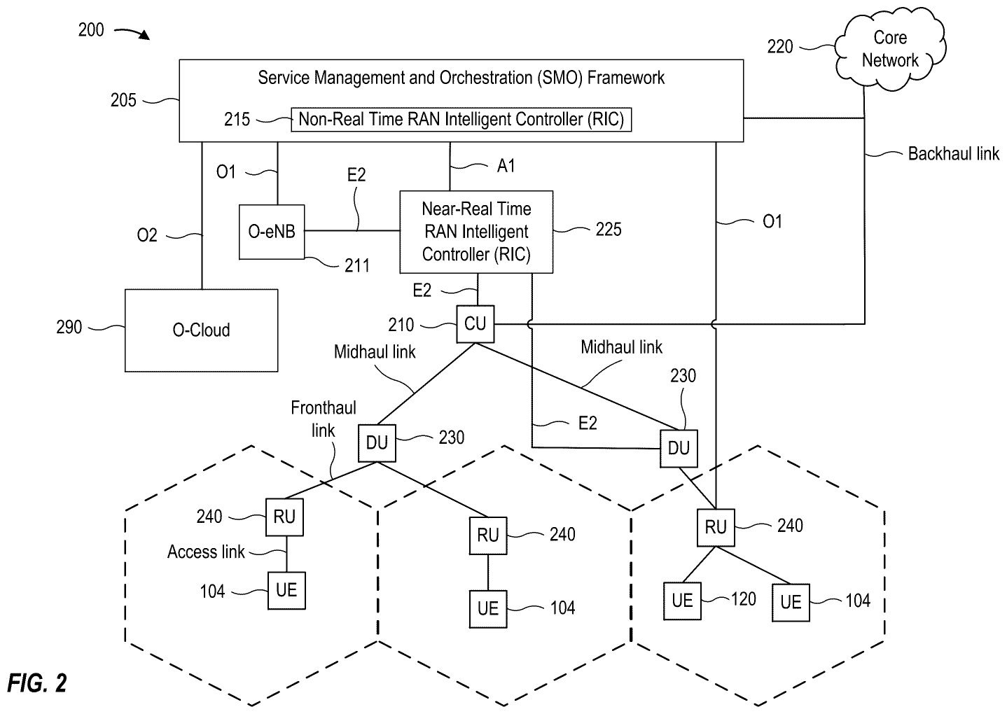

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHZ, which is sometimes referred to (interchangeably) as a “millimeter wave” (“mmW” or “mm Wave”). A base station configured to communicate using mm Wave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

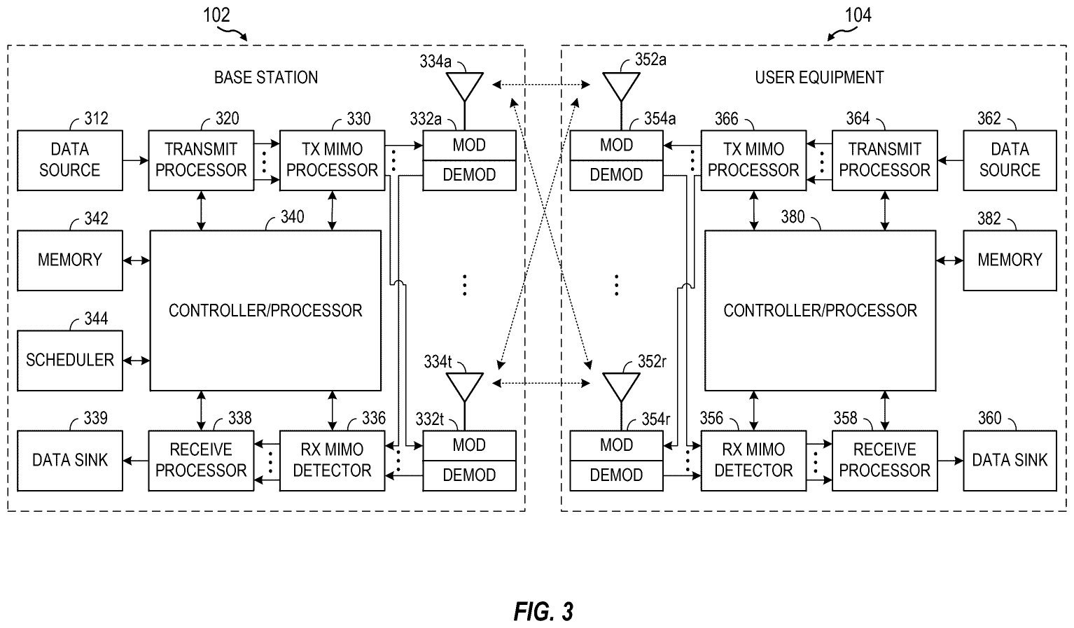

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. DL signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

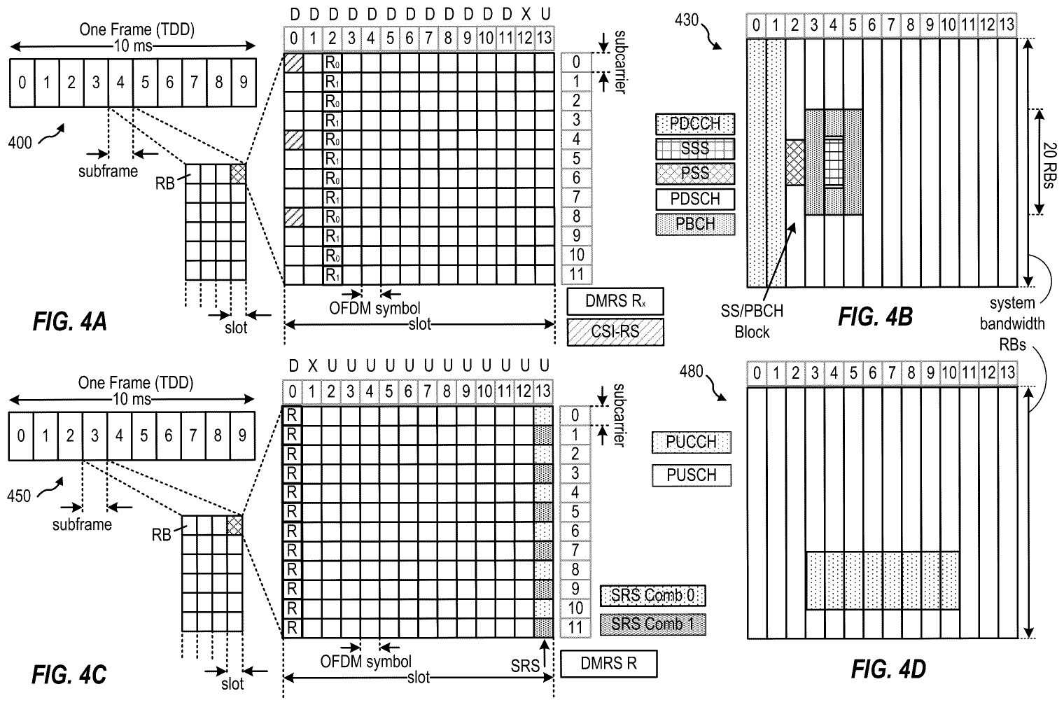

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Sidelink Feedback

While communication between user equipments (UEs) (e.g., UE 104 of FIG. 1) and BSs (e.g., BS 102 of FIG. 1) may be referred to as the access link, and the access link may be provided via a cellular interface (e.g., Uu interface), communication between devices may be referred to as the sidelink.

In some examples, two or more subordinate entities (e.g., UEs 104) may communicate with each other using sidelink signals. Real-world applications of such sidelink communications may include public safety, proximity services, UE-to-network relaying, vehicle-to-vehicle (V2V) communications, Internet of Everything (IoE) communications, Internet of Things (IoT) communications, mission-critical mesh, and/or various other suitable applications. Generally, a sidelink signal may refer to a signal communicated from one subordinate entity (e.g., UE 104 illustrated in FIG. 1) to another subordinate entity (e.g., another UE 104 illustrated in FIG. 1) without relaying that communication through the scheduling entity (e.g., UE or BS), even though the scheduling entity may be utilized for scheduling and/or control purposes.

Various sidelink channels may be used for sidelink communications, including a physical sidelink discovery channel (PSDCH), a physical sidelink control channel (PSCCH), a physical sidelink shared channel (PSSCH), and a physical sidelink feedback channel (PSFCH). The PSDCH may carry discovery expressions that enable proximal devices to discover each other. The PSCCH may carry control signaling such as sidelink resource configurations and other parameters used for data transmissions, and the PSSCH may carry the data transmissions.

For PSSCH or PSCCH transmissions, a transmitting UE 104 may request feedback (e.g., hybrid automatic repeat request (HARQ) feedback such as an acknowledgement (ACK) or a negative ACK (NACK) feedback) to be transmitted in a PSFCH. In particular, HARQ feedback is one technique for increasing the likelihood that data is received correctly over a communication link. HARQ may include a combination of error detection (such as using a cyclic redundancy check (CRC)), forward error correction (FEC), and retransmission (such as automatic repeat request (ARQ)). HARQ may improve throughput at the medium access control (MAC) layer in poor radio conditions (such as low signal-to-noise conditions). In some implementations, a device may support same-slot HARQ feedback, where the device may provide HARQ feedback in a specific slot for data received in a previous symbol in the slot. In some other implementations, the device may provide HARQ feedback in a subsequent slot, or according to some other time interval.

Accordingly, where a transmitting UE 104 requests feedback from a receiving UE 104, the receiving UE 104 may monitor for PSSCH or PSCCH transmissions and provide feedback to the transmitting UE 104 over the PSFCH in accordance with the request. The receiving UE 104 may select a PSFCH resource from a resource pool (e.g., corresponding to a plurality of PSFCH resources), which may not be a dedicated resource pool. For example, the resource pool may be shared with one or more other UEs 104.

The receiving UE 104 may select the PSFCH resource in accordance with a set of parameters associated with sidelink feedback. For example, a periodPSFCHresource parameter may indicate or define a period in slots for a PSFCH transmission in a resource pool. The supported periods may be 0, 1, 2, or 4 (where 0 means that there is no PSFCH available), among other examples. Further, a PSFCH transmission timing may be during a first slot including a PSFCH resource after a scheduled PSSCH and after a time period after the scheduled PSSCH. The time period may be defined or indicated by a MinTimeGapPSFCH parameter. Further, an sl-PSFCH-RB-Set parameter may define an M_{PRB,set}^{PSFCH} variable, which may indicate a quantity of a set of physical resource blocks (PRBs) in a resource pool for PSFCH in a slot. In some aspects, this quantity may be split between N_{PSSCH}^{PSFCH} (a quantity of PSSCH slots corresponding to a PSFCH slot) and N_{subch} (a quantity of sub-channels for a resource pool). In other words, each subchannel and slot includes M_{subch,slot}^{PSFCH} PRBs, wherein M_{subch,slot}^{PSFCH} may be defined in accordance with Equation 1. Further, there may be a time first mapping from PSSCH resources to PSFCH PRBs and a PSFCH resource pool size R_{PRB,CS}^{PSFCH} may be defined in accordance with Equation 2.

$${M}_{subch , slot}^{PSFCH} = \frac{{M}_{PRB , set}^{PSFCH}}{{N}_{PSSCH}^{PSFCH} \times {N}_{subch}} \qquad ( 1 )$$

$${R}_{PRB , CS}^{PSFCH} = {N}_{type}^{PSFCH} \times {N}_{CS}^{PSFCH} \times {M}_{subch , slot}^{PSFCH} \qquad ( 2 )$$

As shown in Equation 2, N_{CS}^{PSFCH} may be a quantity of cyclic shift pairs, configured per resource pool (where a pair is for indicating either ACK or NACK, such that one pair is capable of conveying 1 bit of information). N_{type}^{PSFCH} may be set to 1 or equal to a quantity of subchannels for a corresponding PSSCH N_{subch}^{PSSCH}. In other words, a value of N_{type}^{PSFCH} may indicate whether, for the subchannels in a PSSCH slot, a PSFCH resource pool is shared or not. Within a PSFCH resource pool, a PSFCH resource may be indexed by PRB index first and by cyclic shift pair index second.

Using such parameters, the receiving UE 104 may select or otherwise determine a PSFCH resource in accordance with a value of (P_{ID}+M_{ID})mod R_{PRB,CS}^{PSFCH}, where P_{ID} may be a physical source ID from sidelink control information (SCI), such as second stage SCI (SCI-2), including SCI 2-A or SCI 2-B, for PSSCH and M_{ID} may be set to 0 or an identity of the receiving UE 104 (such as the UE receiving the PSSCH). As such, for unicast- or NACK-based transmission, M_{ID}=0 and the receiving UE 104 may send an ACK or a NACK, or exclusively a NACK, at a source ID-dependent resource in the PSFCH resource pool. For groupcast, the receiving UE 104 may select one PSFCH resource from the PSFCH resource pool and transmit an ACK or a NACK over the selected PSFCH resource.

In some scenarios, UEs 104 may support a sequence-based PSFCH format with one symbol (excluding an automatic gain control (AGC) training period). For example, UEs 104 may support a sequence-based PSFCH format for unicast and groupcast signaling, including for groupcast options 1 and 2 (where groupcast option 1 may refer to exclusively NACK transmissions for sidelink groupcast feedback and groupcast option 2 may refer to ACK or NACK transmissions for sidelink groupcast feedback). For sequence-based PSFCH formats with one symbol (excluding the AGC training period), a UE 104 may use 1 PRB and may indicate 1 bit. To indicate 1 bit of feedback information (such as HARQ-ACK) in PSFCH, UEs 104 may differentiate between ACK and NACK by using different cyclic shifts of a same base sequence in a same PRB (where a cyclic shift corresponding to an ACK may not be defined or used for groupcast option 1).

For such a sequence-based PSFCH, a UE 104 may transmit the 1 bit of HARQ-ACK information via a length-12 sequence with different cyclic shifts. For multi-bit HARQ-ACK information on a PSFCH, a length-12 sequence in one PRB may be insufficient. For example, to convey multiple feedback bits (such as multiple ACKs or NACKs, or a combination of ACKs and NACKs) in one PRB, a UE 104 may use additional cyclic shifts, which may take away cyclic shifts that other UEs 104 may have otherwise used to multiplex sidelink feedback in the same PRB, thus reducing a multiplexing capability of the system. In other words, the more bits of HARQ-ACK information conveyed by one user over a PSFCH resource, the fewer users can be multiplexed in the same PSFCH resource.

In certain aspects, communicating UEs 104 may support a PSFCH design capable of conveying multi-bit feedback across multiple resource blocks without or minimally impacting a multiplexing capability of the system. For example, a receiving UE 104 may monitor for one or more sidelink data messages from a transmitting UE 104 and may transmit, to the transmitting UE 104 over multiple resource blocks of a PSFCH, a feedback message indicating multiple feedback bits associated with the sidelink data messages. The receiving UE 104 may indicate or otherwise convey the multiple feedback bits via various sequence types. In such implementations, each of the multiple length-12 sequence repetitions may be associated with a same base sequence and the first UE 115 may indicate an ACK or NACK via a specific cyclic shift of each of the multiple length-12 sequences.

In other aspects, the receiving UE 104 may support one length-N sequence spanning multiple resource blocks. The length-N sequence may be associated with N orthogonal base sequences and the receiving UE 104 may support a quantity of cyclic shifts for each base sequence. In such implementations, the receiving UE 104 may indicate a specific bit stream (such as a series of two or more bit values) that maps to a sequence of ACKs or NACKs, or both, via a combination of a specific base sequence and a specific cyclic shift. Additionally, or alternatively, the receiving UE 104 may support one or more coding schemes and PSFCH resource selection procedures associated with conveying multi-bit feedback.

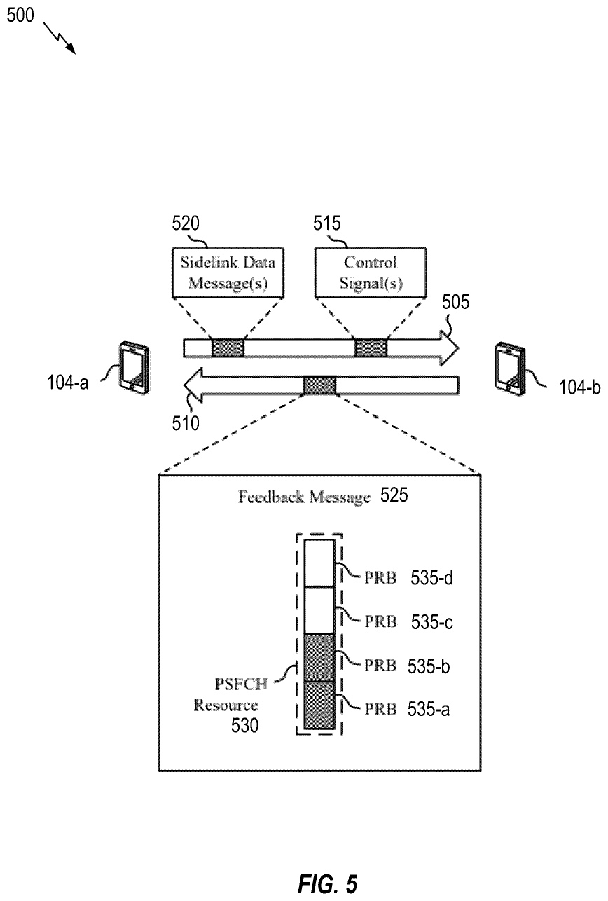

FIG. 5 depicts an example signaling diagram 500 that supports multi-bit feedback via a sidelink feedback channel. Signaling diagram 500 may implement or be implemented to realize aspects of wireless communications network 100. For example, signaling diagram 500 may illustrate communication between a UE 104-a (e.g., a transmitting UE) and another UE 104-b (e.g., a receiving UE), which each may be an example of a UE 104 as illustrated by and described with reference to FIG. 1. In certain aspects, UE 104-a and UE 104-b may support a PSFCH design capable of conveying multi-bit feedback across multiple resource blocks.

UE 104-a may transmit to UE 104-b via a sidelink 505 (which may be an example of a forward link) and the UE 104-b may transmit to UE 104-a via a sidelink 510 (which may be an example of a reverse link). UE 104-a may transmit one or more control signals 515 to UE 104-b scheduling one or more sidelink data messages 520. For example, the one or more control signals 515 may indicate a time and frequency resource allocation, such as a PSSCH resource allocation, for the one or more sidelink data messages 520. The one or more control signals 515 may be an example of an SCI transmission (such as one or both of a first stage SCI (SCI-1) transmission and an SCI-2 transmission) or may be an example of a PC5-radio resource control (RRC) transmission, or both. The one or more sidelink data messages 520 may be examples of one or more PSSCH transmissions. In accordance with receiving the one or more control signals 515, UE 104-b may monitor the indicated time and frequency resource allocation for the one or more sidelink data messages 520.

UE 104-a may, in certain aspects, request feedback associated with the one or more sidelink data messages 520. UE 104-a may request the feedback associated with the one or more sidelink data messages 520 via the one or more control signals 515 or via other signaling. As such, UE 104-b may attempt to receive the one or more sidelink data messages 520 in accordance with the one or more control signals 515 and may provide feedback to UE 104-a in accordance with whether UE 104-b successfully receives the one or more sidelink data messages 520 or fails to receive the one or more sidelink data messages 520. The feedback may indicate multiple feedback bits (such as multiple HARQ-ACK information bits) associated with the one or more sidelink data messages 520, and UE 104-b may transmit the feedback via a feedback message 525 on a PSFCH resource 530.

In certain aspects, UE 104-b may transmit the feedback message 525 over multiple PRBs 535 on PSFCH resource 530 to convey the multiple feedback bits. For example, PSFCH resource 530 may include a PRB 535-a, a PRB 535-b, a PRB 535-c, and a PRB 535-d (which may collectively or generally be referred to as PRBs 535) and, as shown in the example of signaling diagram 500, UE 104-b may transmit the feedback message 525 over PRB 535-a and PRB 535-b. Generally, UE 104-b may use X PRBs 535 for the feedback message 525, where X may be configured (such as via RRC signaling) per resource pool or may be preconfigured (such as hardcoded or defined in a specification) at UE 104-b. X may be 2, 4, or other values.

UE 104-b may transmit the feedback message 525 via a sequence-based format and may generate or select one or more sequences for the feedback message 525 in various manners. In certain aspects, UE 104-b may use multiple length-12 sequence repetitions on the PRB 535-a and the PRB 535-b. In certain aspects, UE 104-a and UE 104-b may support a relatively longer sequence spanning multiple PRBs 535 of the PSFCH resource 530 to convey multiple feedback bits via the feedback message 525. Additionally, or alternatively, in certain aspects, UE 104-a and UE 104-b may apply one or more coding schemes to support a relatively larger payload (such as to support multiple feedback bits) and to support using more than one PRB 535 (such as PRB 535-a and PRB 535-b) in PSFCH resource 530.

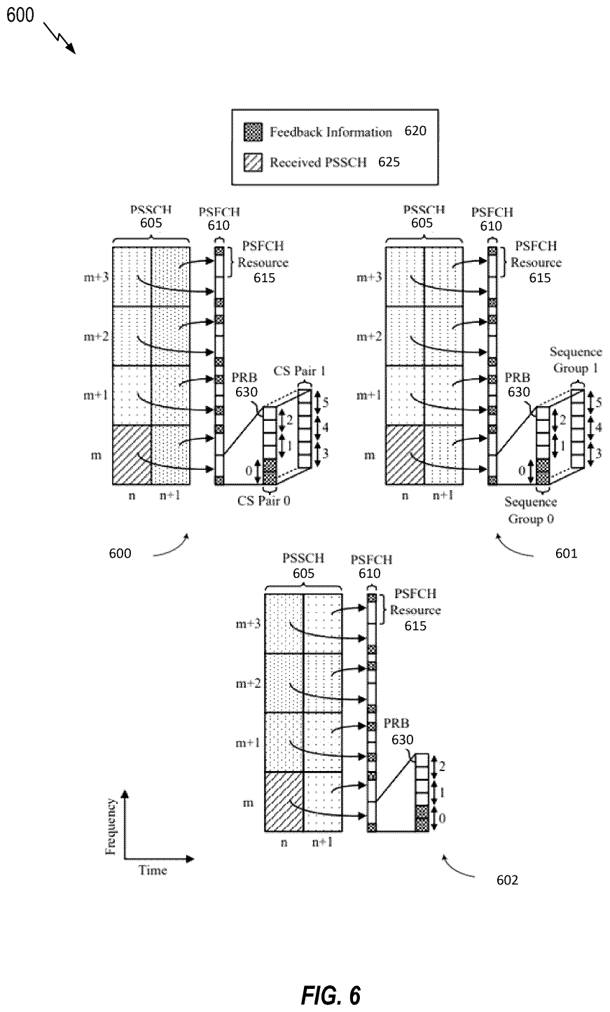

Additional details relating to the use of multiple length-12 sequence repetitions, one relatively longer sequence, or a coding scheme to convey multiple feedback bits, are illustrated by and described with reference to FIG. 6.

In certain aspects, UE 104-a and UE 104-b may support a PSFCH resource selection procedure that is related to one or more parameters associated with indicating multiple feedback bits via feedback message 525 over multiple PRBs 535. For example, UE 104-b may select PSFCH resource 530 from a resource pool (such as a PSFCH resource pool) that is related to one or more of a quantity of PRBs 535 per PSFCH resource 530 (which may be denoted by X), a maximum or upper limit quantity of feedback bits (such as HARQ-ACK information bits) that can be carried per PSFCH resource 530 (which may be denoted by Y), and a quantity of cyclic shifts per resource pool (which may be denoted by M_{CS}). UE 104-b may select the PSFCH resource 530, or may select the resource pool including the PSFCH resource 530, in accordance with one or more parameters and formulas associated with a quantity of available PRBs 535 and a quantity of dimensions in which PSFCH resources 530 can be multiplexed.

A quantity of PSFCH resources 530 available for multiplexing HARQ-ACK information in a PSFCH (which may be denoted by R_{PRB,CS}^{PSFCH}) may be defined in accordance with Equation 3,

$${R}_{PRB , CS}^{PSFCH} = {N}_{type}^{PSFCH} \times {N}_{PSFCH} \times {M}_{subch , slot}^{PSFCH} \qquad ( 3 )$$

where M_{subch,slot}^{PSFCH} is defined in accordance with Equation 4,

$${M}_{subch , slot}^{PSFCH} = \frac{{M}_{PRB , set}^{PSFCH}}{X \times {N}_{PSSCH}^{PSFCH} \times {N}_{subch}} \qquad ( 4 )$$

where M_{PRB,set}^{PSFCH} represents the number of the set of PRBs 535 that are allocated for a PSFCH in a slot. The quantity of the set of PRBs 535 that are allocated for a PSFCH in a slot (M_{PRB,set}^{PSFCH}) may be split between a quantity of PSSCH slots corresponding to a PSFCH slot (which may be denoted by N_{PSSCH}^{PSFCH}) and a quantity of PSSCH resources in a slot (which may be equivalently referred to as a quantity of subchannels and denoted by N_{subch}). As such, a quantity of resource block groups (RBGs) for each subchannel and slot pair may be defined in accordance with Equation 4.

Further, as shown in Equation 3, N_{type}^{PSFCH} may be set to 1 or may be equal to a quantity of subchannels for a corresponding PSSCH (which may be denoted by N_{subch}^{PSSCH}) and may indicate whether a PSFCH resource pool is shared. As such, N_{type}^{PSFCH} may be referred to herein as a first value associated with indicating whether the resource pool is shared.

Additionally, UE 104-b may select a value for N_{PSFCH}, which may be referred to herein as a second value associated with a quantity of dimensions in which PSFCH resources can be multiplexed, in accordance with one of various options. The option according to which the UE 115-b selects a value for N_{PSFCH} may vary in accordance with whether the UE 115-b uses multiple length-12 sequence repetitions, one relatively longer sequence, or a coding scheme to convey multiple feedback bits via the feedback message.

FIG. 6 shows example PSFCH multiplexing schemes 600, 601, and 602 that supports multi-bit feedback via a sidelink feedback channel. The PSFCH multiplexing schemes 600, 601, and 602 may implement or be implemented to realize aspects of wireless communications network 100 and/or signaling diagram 500. For example, a receiving UE 104, which may be an example of a UE 104 as illustrated by and described with reference to FIG. 1 or UE 104-b as illustrated by and described with reference to FIG. 5, may leverage PSFCH multiplexing schemes 600, 601, and 602 to identify or otherwise ascertain a value for N_{PSFCH}.

As shown in PSFCH multiplexing schemes 600, 601, and 602, a set of PSSCHs 605 may be present across a resource grid associated with slots n and n+1 and subchannels m, m+1, m+2, and m+3. Each of the PSSCHs 605 may correspond to a different PSFCH resource 615 within a PSFCH slot 610. For a received PSSCH 625 (corresponding to a PSSCH located in slot n and subchannel m), UE 104 (e.g., receiving UE 104) may transmit multi-bit feedback information 620 over multiple PRBs 630 within a corresponding PSFCH resource 615. A quantity of dimensions in which that PSFCH resource 615 can be multiplexed, and thus a value of N_{PSFCH}, may vary across the PSFCH multiplexing schemes 600, 601, and 602.

As illustrated by PSFCH multiplexing scheme 600, which may be associated with aspects where UE 104 uses multiple length-12 sequence repetitions across multiple PRBs 630 and uses different cyclic shift pairs to differentiate between an ACK or a NACK for each sequence, a quantity of PSFCH resources 615 that can be multiplexed may depend on or be associated with a quantity of cyclic shift pairs (which may be configured per resource pool). In other words, N_{PSFCH} may be set equal to a quantity of cyclic shift pairs, which may be configured per resource pool. As such, if UE 104 supports two cyclic shift pairs, N_{PSFCH}=2. In such aspects, within a PSFCH resource pool, a PSFCH resource 615 may be indexed by RBG index first and by cyclic shift pair index second. Further, although shown as supporting two cyclic shift pairs, UE 104 may support any number of cyclic shift pairs.

As illustrated by PSFCH multiplexing scheme 601, which may be associated with aspects where UE 104 uses one length-N sequence spanning multiple PRBs 630 and uses different base sequence and cyclic shift combinations to differentiate between different sequences of ACKs, NACKs, or a combination of ACKs and NACKs, a quantity of PSFCH resources 615 that can be multiplexed may depend on or be associated with a quantity of sequence groups G (per resource pool). In other words, N_{PSFCH} may be set equal to a quantity of sequence groups (which may be denoted by G) per resource pool, which may be equal to X*N_{sc}^{RB}*M_{sc CS}/2^{Y}. As such, if UE 104 supports two sequence groups (such as G=2), N_{PSFCH}=2. In such implementations, within a PSFCH resource pool, a PSFCH resource 615 may be indexed by RBG index first and by sequence group index second. Further, although shown as supporting two sequence groups, Ue 104 may support any number of sequence groups.

As illustrated by PSFCH multiplexing scheme 602, which may be associated with aspects where UE 104 uses a coding scheme to convey multi-bit feedback information 620 with low or minimal cyclic redundancy check (CRC) overhead, a quantity of PSFCH resources 615 that can be multiplexed may be equal to 1. Accordingly, in the example PSFCH multiplexing scheme 602, N_{PSFCH}=1 (N_{PSFCH} may be statically fixed to 1). Further, within a PSFCH resource pool, a PSFCH resource 615 may be indexed by RBG index.

In summary, for PSCCH/PSSCH transmission, sidelink HARQ feedback (e.g., ACK and/or NACK feedback) for a PSSCH may be transmitted on a PSFCH. The PSFCH may be a single resource block symbol with a same format as a physical uplink control channel (PUCCH) format 0. The PSFCH may be 1 bit.

Accordingly, a receiving UE 104 may be unable to transmit more than one bit (e.g., an ACK bit or a NACK bit) per PSFCH resource. Thus, if receiving UE 104 receives multiple sidelink messages from a transmitting UE 104, receiving UE 104 may transmit HARQ feedback for a first sidelink message on a first PSFCH resource, and may transmit HARQ feedback for a second sidelink message on a second PSFCH resource.

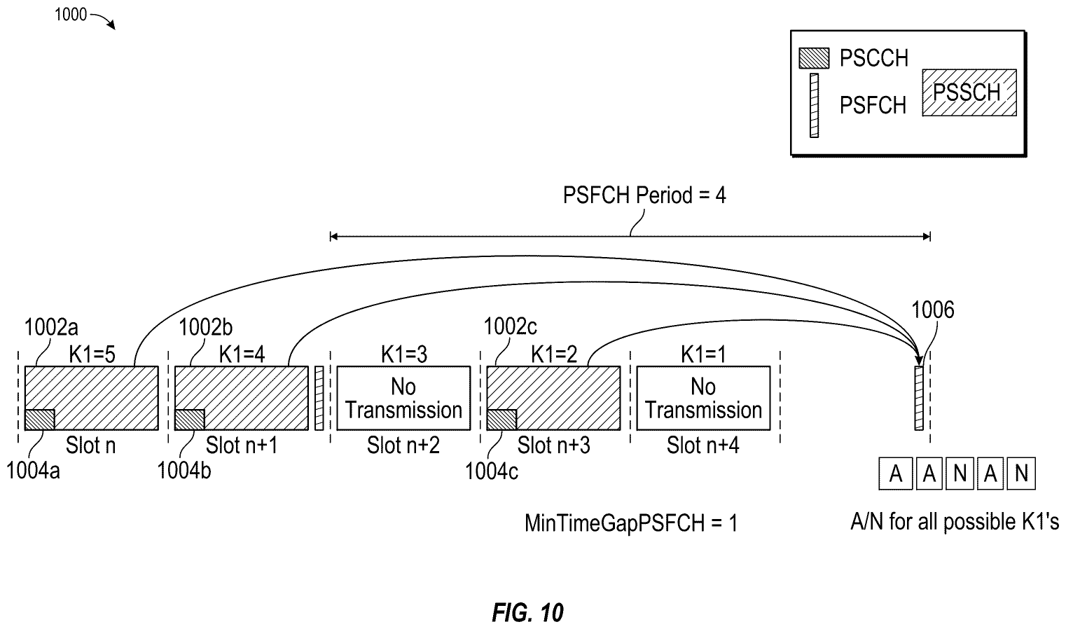

In some cases, as illustrated in FIG. 10, where receiving UE 104 needs to transmit multiple bits on multiple PSFCH resources, receiving UE 104 may need to send sidelink HARQ feedback that is multiplexed (e.g., frequency division multiplexed (FDMed) on the PSFCH). For example, UE 104 may multiplex HARQ feedback for the first sidelink message on the first PSFCH resource with HARQ feedback for the second sidelink message on the second PSFCH resource. UE 104 may send sidelink HARQ feedback that is multiplexed when multiple PSSCHs are received from the same transmitting UE 104. Receiving UE 104 may also receive multiple PSSCHs from different transmitting UEs 104, and receiving UE 104 may send a PSFCH to each of the transmitting UEs 104. However, a receiving UE 104 may be limited as to how many PSFCH resources receiving UE 104 can multiplex in the same symbol. For example, a number of PSFCH resources that a receiving UE 104 may multiplex in a same symbol may depend on capability of receiving UE 104.

In some other cases, such as 3GPP Release 16 Sidelink, ACK/NACK bits may not be multiplexed. Accordingly, receiving UE 104 may need to transmit multiple PSFCHs. Transmitting multiple ACK/NACK bits, targeting a same transmitting UE 104, in different PSFCH transmissions may cause each PSFCH transmission to not be optimized.

However, introducing multi-bit PSFCH transmissions may be desirable for many scenarios, such as sidelink eMBB, where there may be a higher likelihood of a continuous PSSCH stream being transmitted to the same receiving UE 104. Multi-bit PSFCH transmission may also be applicable to sidelink carrier aggregation, which may increase the number of ACK or NACK bits that can be transmitted at a given time. Additionally, for sidelink applications in unlicensed radio frequency spectrum bands, wireless devices may be unable to configure frequent PSFCH opportunities (e.g., possible PSFCH transmissions may have a periodicity that is larger than 4 slots). As mentioned herein, using conventional techniques to transmit multiple ACK or NACK bits may involve (1) multiplexing many PSFCH resources in a PSFCH transmission or (2) transmitting multiple PSFCH transmissions each having a PSFCH resource including a single ACK/NACK bit.

### Aspects Related to Multi-Bit Sidelink Feedback

Aspects of the present disclosure may support the transmission of feedback for multiple physical sidelink shared channel (PSSCH) occasions, occurring over multiple slots, in a single physical sidelink feedback channel (PSFCH) resource. In particular, a receiving user equipment (UE) may be scheduled to receive one or more sidelink data messages from a transmitting UE during a time period spanning multiple slots, wherein each slot includes at least one PSSCH occasion. In certain aspects, the receiving UE may be requested to provide feedback for the scheduled one or more sidelink data messages. In certain aspects, the receiving UE may provide feedback for each PSSCH occasion, even for PSSCH occasions the receiving UE is not scheduled to receive a sidelink data message. The receiving UE may provide the feedback in a single PSFCH resource (e.g., as opposed to transmitting feedback corresponding to each PSSCH occasion in different PSFCH resources). As a result, the receiving UE may experience higher throughput and greater signaling efficiency, among other benefits.

In certain aspects, a sidelink codebook may be used to convey the feedback for the multiple PSSCH occasions occurring over the multiple slots. The codebook may include a sequence of bits conveying acknowledgement (ACK) or negative ACK (NACK) feedback for each of the multiple PSSCH occasions. For example, a receiving UE may generate a codebook indicating ACK/NACK bits, wherein each bit in the codebook corresponds to a PSSCH occasion of a slot of a plurality of slots (e.g., more than one slot) occurring during a time period (e.g., a hybrid automatic repeat request (HARQ) timeline) configured for the receiving UE. In certain aspects, there may be multiple PSSCH occasions in a slot, such as corresponding to multiple spatial layers and/or multiple frequency carriers, and accordingly there may be multiple ACK/NACK bits for a given slot. In certain aspects, the ACK/NACK bits for PSSCH occasions on different layers within the slots of a time period are conveyed in a single PSFCH resource, such that where the number of slots of the time period is N and the number of layers used for communication on a particular frequency carrier/subchannel is L, the number of ACK/NACK bits indicated in the PSFCH resource associated with the time period and subchannel is N×L. In certain aspects, PSSCH occasions on different subchannels are conveyed in different PSFCH resources.

In certain aspects, a receiving UE may be configured with a fixed HARQ timeline, meaning each time period has the same number of slots. Accordingly, the size of a codebook generated by the receiving UE for conveying multi-bit feedback may be fixed, where a number of bits included in the codebook correspond to the number of PSSCH occasions occurring within the fixed time period. In certain other aspects, a receiving UE may be configured with a dynamic HARQ timeline, where different time periods may be configured with a different number of slots. Accordingly, the size of a codebook generated by the receiving UE for conveying multi-bit feedback may be based on the number of PSSCH occasions within the particular time period, where a number of bits included in the codebook correspond to the number of PSSCH occasions occurring within the particular time period. Accordingly, a number of bits included in a codebook generated by the receiving UE for conveying multi-bit feedback may be dynamic (e.g., number of bits included in a first codebook may be more or less than a number of bits included in a second codebook).

In certain aspects, the techniques described herein provide for extending type-1 HARQ codebook usage to sidelink applications such that a receiving UE generates a type-1 HARQ codebook for providing multi-bit feedback in a single PSFCH resource. Unlike type-2 HARQ codebook and type-3 HARQ codebook designs for sidelink applications, type-1 HARQ codebook design in sidelink may not require a sidelink acknowledgement index (SAI) counter, nor a HARQ-ACK trigger, in a sidelink control information (SCI) grant. For example, for type-2 HARQ codebook in sidelink, an SAI counter may be introduced in an SCI grant from a transmitting UE, where the SAI indicates to a receiving UE how many ACK/NACK the transmitting UE is expecting the receiving UE to transmit back to the transmitting UE in a corresponding PSFCH instance. The SAI field may be introduced to allow the receiving UE to detect missing SCI (e.g., SCI-2) such that the receiving UE can perform necessary padding on the HARQ codebook. The SAI may also be introduced to allow the transmitting UE to interpret the feedback bits and possibly determine transport blocks (TBs) for which feedback is missing or is otherwise not received or indicated by the receiving UE. Alternatively, for type-3 HARQ codebook in sidelink, a HARQ-ACK feedback trigger may be introduced in an SCI grant from a transmitting UE, where a value for the HARQ-ACK feedback trigger may indicate to a receiving UE whether or not to transmit HARQ-ACK feedback. In certain aspects described herein, however, type-2 or type-3 HARQ codebook designs may be utilized.

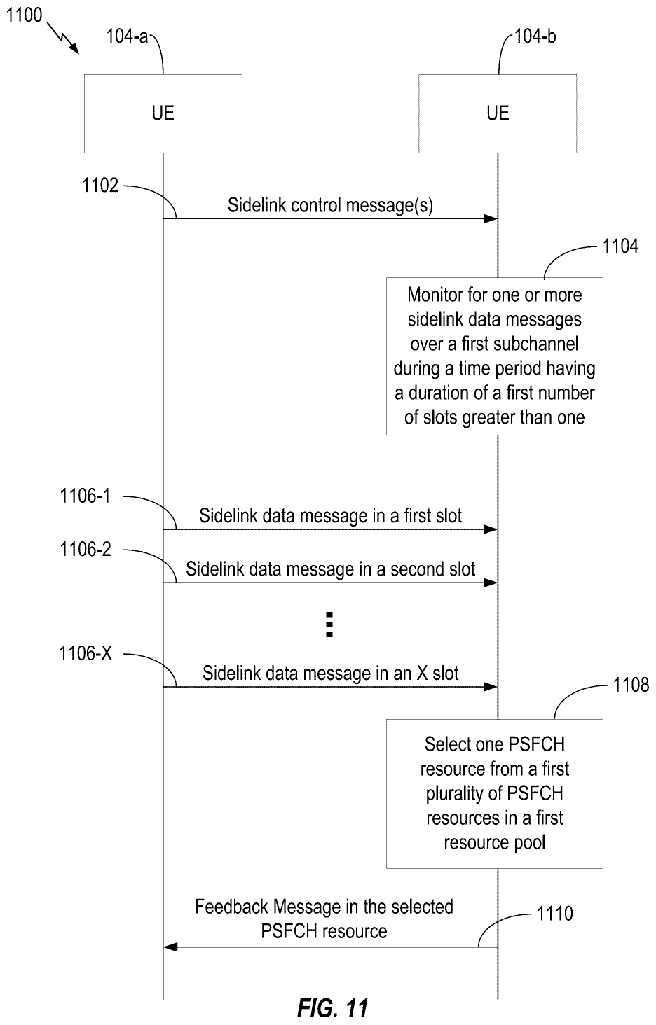

Certain aspects of the present disclosure provide improved resource mapping to enable a receiving UE to provide feedback for multiple PSSCH occasions, occurring over multiple slots, in a single PSFCH resource. More specifically, aspects of the present disclosure provide techniques for mapping multiple PSSCH occasions to a particular PSFCH resource for the transmission of a feedback message associated with the multiple PSSCH occasions. In certain aspects, hashing (e.g., selection of a PSFCH resource) may be based on at least one of an identifier (ID) of a transmitter UE transmitting one or more sidelink data messages in the PSSCH occasions or a groupcast ID associated with the one or more sidelink data messages transmitted in the PSSCH occasions. The improved resource mapping described herein may allow for collision avoidance among receiving UEs transmitting sidelink feedback. Improved resource mapping may be described in detail at least with respect to FIG. 11.

In certain aspects, each PSFCH resource may include a plurality of physical resource blocks (PRBs) (e.g., as previously illustrated in FIG. 6). Further, certain aspects described herein may support a PSFCH resource having a block-interlaced waveform to meet uplink occupancy channel bandwidth (OCB) requirements, which may be driven by requirements for using the unlicensed hand (but may also be used in the licensed band).

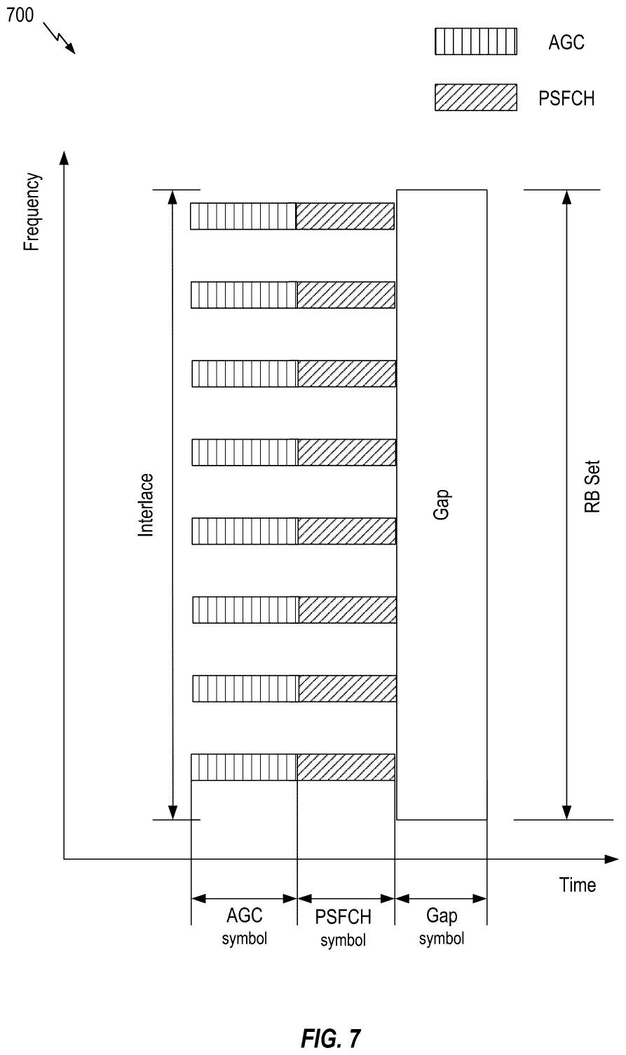

FIG. 7 illustrates an interlaced PSFCH transmission 700. Each PSFCH may occupy one interlace in one resource block (RB) set. As shown in FIG. 7, the interlaced PSFCH transmission 700 uses non-consecutive PRBs to meet OCB requirements. In an example, the interlaced PSFCH may be separated by 10 PRBs (e.g., much larger than 3GPP Release 16 sidelink PSFCH).

In certain aspects, similar to physical uplink control channel (PUCCH) formats PF0 and PF1 introduced in 3GPP Release 16 New Radio Unlicensed Spectrum (NR-U), PSFCH formats are supported to include mapping to physical resources of one full interlace in 20 MHz. In certain aspects, various alternatives may be used for sequence type and mapping including (1) repetition of the length-12 sequence in each PRB of an interlace with a mechanism to control peak-to-average power ratio/cubic metric (PAPR/CM) considering cycling cyclic shifts across PRBs, (2) mapping of a single long sequence to the PRBs of an interlace (e.g., with index modulation), and (3) orthogonal frequency division multiplexing waveform using all resource blocks in the interlace (and to improve user multiplexing, orthogonal cover code 2 (OCC2) or OCC4 may be introduced).

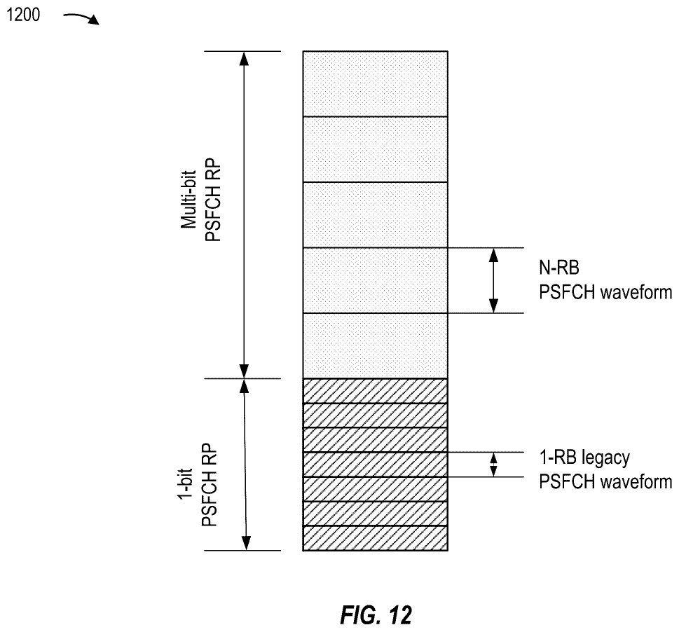

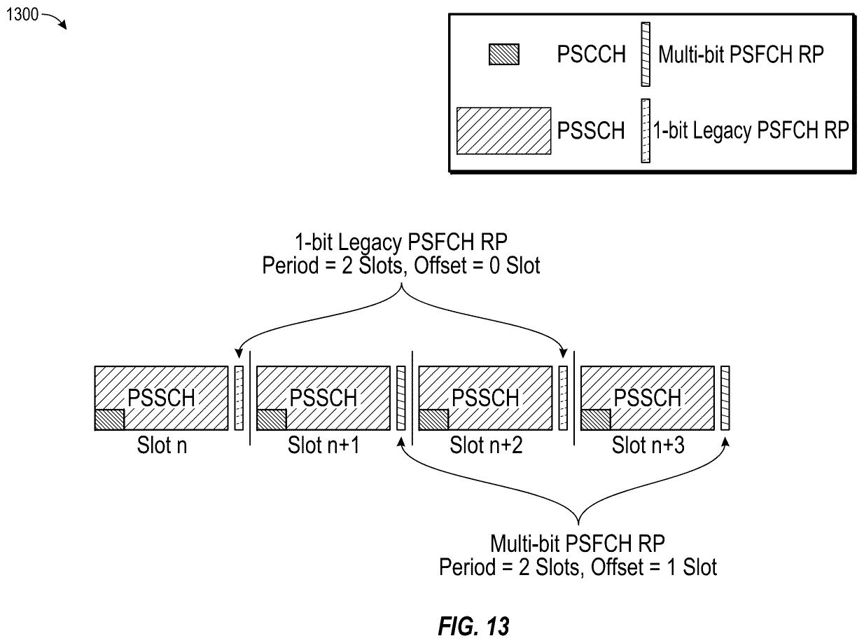

Further, in certain aspects, a receiving UE may be scheduled to receive one or more sidelink data messages from a same transmitting UE over multiple PSSCH occasions, where the one or more sidelink data messages comprise a mixture of different cast types. For example, the different cast types may include unicast, groupcast, or broadcast transmissions. Accordingly, certain aspects described herein provide various options for multi-bit feedback for multiple PSSCH occasions associated with different cast types. Multi-bit feedback for different cast types may be described in detail at least with respect to FIGS. 12 and 13.

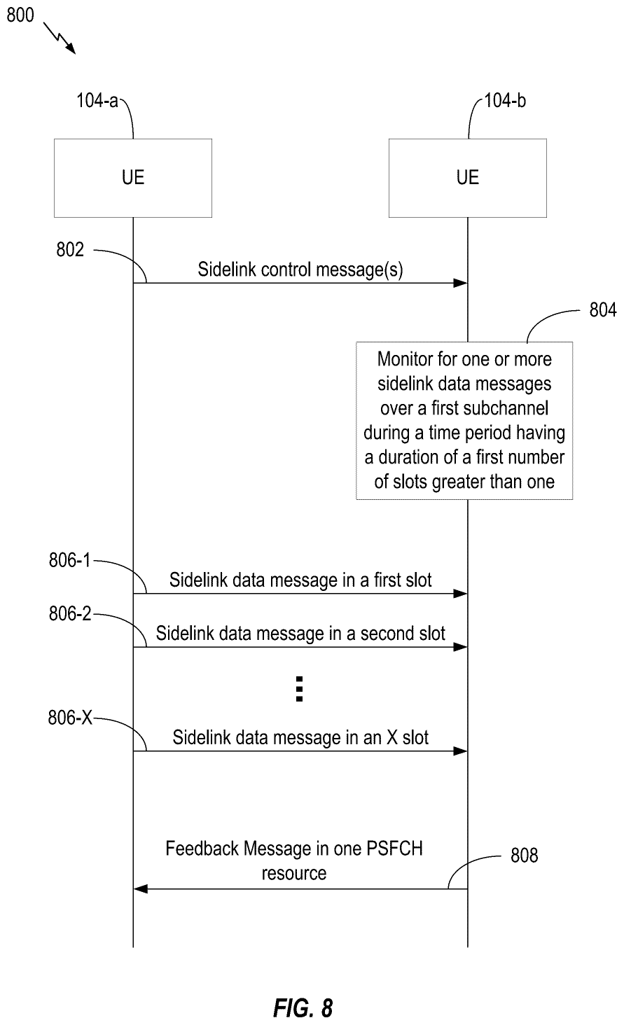

FIG. 8 is a call flow diagram 800 illustrating example sidelink signaling for providing multi-bit feedback for multiple PSSCH occasions occurring over multiple time periods in a single PSFCH resource. As shown in call flow diagram 800, a transmitting UE, UE 104-a, may be in sidelink communication with a receiving UE, UE 104-b. According to aspects described herein, UE 104-a and UE 104-b may support a PSFCH design capable of conveying multi-bit feedback in a single PSFCH resource.

As shown in FIG. 8, at 802, UE 104-a may transmit sidelink control message(s) to UE 104-b. Each sidelink control message from UE 104-a may schedule UE 104-b to receive a sidelink data message from the transmitting UE on a PSSCH occasion occurring in a slot. In particular, control information (e.g., SCI) in each sidelink control message may schedule a sidelink data message.

In certain aspects, sidelink control message(s) from UE 104-a may include radio resource control (RRC) signaling that indicates a minimum PSFCH time gap (e.g., a minimum time duration between PSSCH transmission and PSFCH transmission), a PSFCH periodicity (e.g., a number of slots between PSFCH resources), a mapping between PSSCH resources and PSFCH resources, a PSFCH resource pool configuration, an algorithm for identifying PSFCH resources based on identifiers of the UEs, or a combination thereof. Such RRC signaling may be separate from SCI scheduling a sidelink data message, and for example, may occur less frequently and prior to communication of SCI.

At 804, UE 104-b may monitor for one or more sidelink data messages over a first subchannel during a specified time period, based on the received sidelink control message(s) at 802. The specified time period may be over multiple slots (e.g., a duration of a number of slots greater than one). For example, where UE 104-b receives a first sidelink control message at 802 scheduling a first sidelink data message on a first PSSCH occasion in a first slot, UE 104-b may monitor for the first sidelink data message on the first PSSCH occasion in the first slot. Further, where UE 104-b receives a second sidelink control message at 802 scheduling a second sidelink data message on a second PSSCH occasion in a second slot, UE 104-b may monitor for the second sidelink data message on the second PSSCH occasion in the second slot.

At 806, UE 104-a may transmit one or more sidelink data messages over the first subchannel during the specified time period. For example, as shown in the example of FIG. 8, UE 104-a may transmit a first sidelink data message to UE 104-b on a first PSSCH resource in a first slot over the first subchannel at 806-1, transmit a second sidelink data message to UE 104-b on a second PSSCH resource in a second slot over the first subchannel at 806-2, and transmit one or more other sidelink data messages (e.g., up to a sidelink data message transmitted at 806-X) to UE 104-b on different PSSCH resources in different slots over the first subchannel during the specified time period.

At 808, UE 104-b may transmit, to UE 104-a, a feedback message in one PSFCH resource. In particular, the feedback message may be transmitted over a plurality of resource blocks of a single PSFCH resource of a first feedback channel occasion of a set of periodically occurring feedback channel occasions. The feedback message may indicate a plurality of feedback bits associated with the one or more sidelink data messages. For example, the feedback message may include the plurality of feedback bits, or may include a codebook indicative of the plurality of feedback bits, meaning the codebook may include other data that maps to or represents the plurality of feedback bits.

In certain aspects, the plurality of feedback bits includes at least one feedback bit for each slot of the specified time period, and each feedback bit may indicate a corresponding ACK or a corresponding NACK. In certain aspects, a slot may contain multiple PSSCH occasions corresponding to multiple spatial layers and/or multiple frequency carriers. Thus, the plurality of feedback bits may include a feedback bit for each of these PSSCH occasions resulting in multiple feedback bits for the specific slot.

In certain aspects, the plurality of feedback bits includes one or more feedback bits associated with one or more sidelink data messages received in slots of the specified time period. In certain aspects, the plurality of feedback bits includes a feedback bit that is not associated with any sidelink data message. The feedback bit not associated with any sidelink data message may indicate a NACK.

For example, where the specified time period is a duration of four slots, the plurality of feedback bits may include four bits, where each bit corresponds to one slot, and each bit includes an ACK or a NACK. In other words, UE 104-b may transmit an indication of a sidelink type-1 HARQ codebook that includes ACK and/or NACK bits corresponding to each slot of the specified time period. Where UE 104-b is scheduled to receive a sidelink data message on three of the four slots, the plurality of bits in the feedback message may include three ACK or NACK bits. An ACK bit may be used where UE 104-b successfully receives and decodes the scheduled sidelink data message scheduled for the corresponding slot. A NACK bit may be used where UE 104-b does not successfully receive and/or decodes the scheduled sidelink data message scheduled for the corresponding slot. Although only three of the four slots may have a scheduled sidelink data message, the plurality of bits may still include four bits corresponding to each of the four slots in the specified time period. Accordingly, a bit included in the feedback message for the slot for which a sidelink data message is not scheduled may indicate NACK, for padding.

In certain aspects, the feedback message may be reported as a codebook in the single PSFCH resource. More specifically, the feedback message may be reported as a type-1 HARQ codebook in the single PSFCH resource.

As mentioned herein, a receiving UE may be configured with a fixed HARQ timeline or a dynamic HARQ timeline. Accordingly, a multi-bit PSFCH waveform may be exploited to carry type-1 HARQ codebook PSFCH transmission for both fixed and dynamic HARQ timelines.

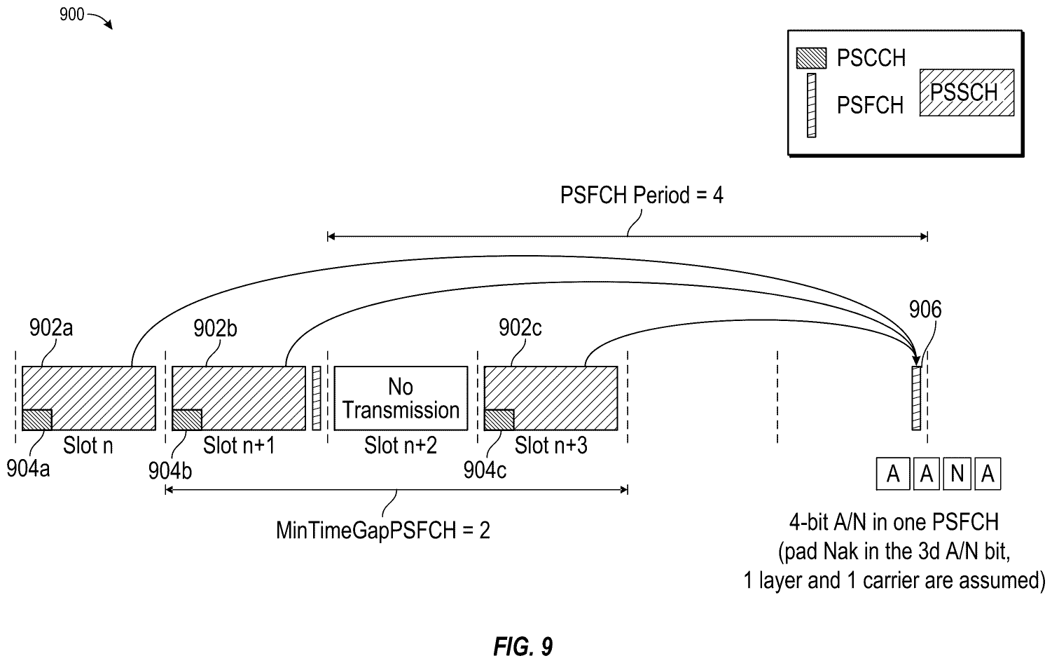

FIG. 9 illustrates example resource mapping 900 that supports techniques for type-1 HARQ codebook PSFCH transmission for a fixed HARQ timeline. In accordance with resource mapping 900, a wireless device, such as a receiving UE, may transmit an indication of a sidelink type-1 HARQ codebook that includes ACK and/or NACK feedback for multiple PSSCH occasions, occurring over multiple slots, in a single PSFCH resource. One or more of the bits of the codebook may correspond to one or more sidelink data messages scheduled and transmitted on the PSSCH occasions occurring over the multiple slots. Further, one or more of the bits of the codebook may not be associated with any sidelink data message on the PSSCH occasions occurring over the multiple slots.

For the fixed HARQ timeline, a PSFCH resource pool may be configured with a PSFCH period of N, where Nis an integer equal to or greater than one. The configured PSFCH period, N, may indicate a number of fixed N slots (e.g., with or without PSCCH/PSSCH transmission) which may map to the same PSFCH occasion for sidelink HARQ feedback. As shown in the example of FIG. 9, the PSFCH resource pool may be configured with a PSFCH period of four, such that four slots, each with a PSSCH occasion, map to a same PSFCH occasion 906 for ACK/NACK feedback transmission. In other words, the size of a codebook transmitted at PSFCH occasion 906 may be fixed to indicate four ACK/NACK bits corresponding to each of the PSSCH occasions of the four slots.

As illustrated, a transmitting UE (e.g., such as UE 104-a in FIGS. 5 and 8) may transmit multiple PSSCH transmissions 902 (e.g., sidelink data messages) to a receiving UE (e.g., such as UE 104-b in FIGS. 5 and 8). In certain aspects, the transmitting UE may transmit a PSCCH transmission 904a scheduling a PSSCH transmission 902a, a PSCCH transmission 904b scheduling a PSSCH transmission 902b, and a PSCCH transmission 904c scheduling a PSSCH transmission 902c. The transmitting UE may transmit the PSSCH transmission 902a to the receiving UE on a PSSCH occasion n during a slot n, may transmit the PSSCH transmission 902b to the receiving UE on a PSSCH occasion n+1 during a slot n+1, and may transmit the PSSCH transmission 902c to the receiving UE on a PSSCH occasion n+3 during a slot n+3. Each of the PSSCH transmissions 902 may be multiplexed with the corresponding PSCCH transmission 904, which may include SCI related to the PSSCH transmissions 902.

After monitoring for the PSSCH transmissions 902 from the transmitting UE, the receiving UE may generate a codebook (e.g., a type-1 HARQ-ACK codebook for sidelink messages) that indicates ACK and/or NACK bits corresponding to the fixed N slots. For example, the codebook may indicate an ACK or NACK bit corresponding to slot n, an ACK or NACK bit corresponding to slot n+1, an ACK or NACK bit corresponding to slot n+2, and an ACK or NACK bit corresponding to slot n+3.

As illustrated, the receiving UE may receive PSSCH transmission 902a during the slot n, may receive PSSCH transmission 902b during the slot n+1, and may receive PSSCH transmission 902c during the slot n+3. Accordingly, bits included in the codebook generated by the receiving UE may indicate an ACK bit corresponding to slot n, slot n+1, and slot n+3.

Further, as illustrated, the receiving UE may not receive a PSSCH transmission during slot n+2, nor may the receiving UE be scheduled to receive a PSSCH transmission during slot n+2. Accordingly, a feedback bit included in the codebook generated by the receiving UE may include a feedback bit for slot n+2, where the feedback bit is not associated with any PSSCH. According to aspects described herein, where a PSSCH in a particular slot is not scheduled, the receiving UE will pad a NACK bit. Accordingly, a feedback bit for slot n+2 may be a NACK bit, for padding.

Thus, the codebook generated by the receiving UE may include an ACK bit for slot n, an ACK bit for slot n+1, a NACK bit for slot n+2, and an ACK bit for slot n+3.

The receiving UE may transmit an indication of the generated codebook to the transmitting UE. The receiving UE may transmit an indication of the generated codebook in accordance with a sidelink feedback configuration, which may include the PSFCH period (e.g., PSFCH period=N=4) and a minimum PSFCH time gap (e.g., denoted as MinTimeGapPSFCH in FIG. 9). The minimum PSFCH time gap may refer to a minimum number of slots between when the receiving UE receives a sidelink message and when the receiving UE can transmit feedback (e.g., HARQ-ACK feedback) for the sidelink message.

For example, the minimum PSFCH time gap in FIG. 9 is configured to be equal to two slots (e.g., MinTimeGapPSFCH=2). Accordingly, because the PSSCH transmission in slot n+3 is at least two slots prior to the PSFCH occasion 906, the receiving UE may be able to transmit HARQ-ACK feedback (e.g., the ACK bit) for PSSCH transmission 902c in slot n+3. In other words, the receiving UE may transmit HARQ-ACK feedback for the PSSCH transmission 902c in the first slot that includes PSFCH resources and is at least two slots after the last slot in which the receiving UE receives PSSCH transmission 902c.

In accordance with this sidelink feedback configuration, the receiving UE may transmit an indication of the generated codebook (e.g., including ACK/NACK bits for multiple PSSCH occasions over multiple slots) to the transmitting UE over a plurality of resource blocks of a single PSFCH resource of PSFCH occasion 906.

The example resource mapping 900 illustrated in FIG. 9 assumes that each of PSSCH transmission 902a, 902b, and 902c are scheduled and transmitted by a same transmitting UE. Alternatively, where a PSSCH transmission is scheduled and transmitted by another transmitting UE, the receiving UE may transmit a different multi-bit feedback (e.g., in another PSFCH resource) for the other transmitting UE. For example, the receiving UE may generate another codebook (e.g., a type-1 HARQ-ACK codebook for sidelink messages) that includes ACK and/or NACK bits corresponding to the fixed N slots. The codebook may include an ACK or NACK bit for a slot where the PSSCH was scheduled by the other UE.

Similar to FIG. 9, FIG. 10 also illustrates example resource mapping 1000 that supports techniques for type-1 HARQ codebook PSFCH transmission. However, FIG. 10 illustrates example resource mapping 1000 that supports techniques for type-1 HARQ codebook PSFCH transmission for a dynamic HARQ timeline. In accordance with resource mapping 1000, a wireless device, such as a receiving UE, may transmit an indication of a sidelink type-1 HARQ codebook that includes ACK and/or NACK feedback for multiple PSSCH occasions, occurring over multiple slots, in a single PSFCH resource. One or more of the bits of the codebook may correspond to one or more sidelink data messages scheduled and transmitted on the PSSCH occasions occurring over the multiple slots. Further, in certain aspects, one or more of the bits of the codebook may not be associated with any sidelink data message on the PSSCH occasions occurring over the multiple slots.

Unlike the fixed HARQ timeline, for the dynamic HARQ timeline, a number of bits included in a codebook generated by the receiving UE may not be fixed. Instead, the number of bits included in a codebook generated by the receiving UE may be based on an offset value, a K1 value, defining a duration between the scheduling of a sidelink data message and transmission of an indication of the generated codebook, containing a bit for the sidelink data message, to the transmitting UE.

However, the type-1 HARQ codebook size may be limited by a threshold. The threshold size of the type-1 HARQ codebook may be based on (1) a number, N_{K1}, of possible K1 values (e.g., a number of possible K1 values which may be satisfied) and (2) a number of spatial layers, L. Accordingly, the type-1 HARQ codebook size may include a number of ACK/NACK bits equal to N_{R1}×L.

The offset value may be an offset value among a number of defined offset values (e.g., that have been preconfigured). The offset value may be included in SCI generated by the transmitting UE, and more specifically, SCI-1 or SCI-2.

For example, as illustrated in example resource mapping 1000, a transmitting UE (e.g., such as UE 104-a in FIGS. 5 and 8) may schedule a receiving UE (e.g., such as UE 104-b in FIGS. 5 and 8) to receive PSSCH transmissions on PSSCH occasions occurring in multiple slots, where each slot include a PSSCH occasion. The transmitting UE may schedule each PSSCH transmission via SCI transmitted in a control channel (e.g., PSCCH), similar to FIG. 9. For example, SCI transmitted in PSCCH 1004a in slot n may schedule PSSCH transmission 1002a in slot n, SCI transmitted in PSCCH 1004b in slot n+1 may schedule PSSCH transmission 1002b in slot n+1, and SCI transmitted in PSCCH 1004c in slot n+3 may schedule PSSCH transmission 1002c in slot n+3. In certain aspects, each of the PSSCH transmissions 1002 may be multiplexed with a corresponding PSCCH transmission 1004, which may include the SCI related to the PSSCH transmissions 1002.

The SCI related to each of the PSSCH transmissions 1002 may include a K1 value. For example, PSSCH transmission 1002 in slot n+3 may be multiplexed with a PSCCH transmission including an SCI having a K1 value set to two. Because a subsequent (e.g., next in time) PSFCH occasion (e.g., PSFCH occasion 1006) for transmitting ACK/NACK bits is two slots in time after the reception of PSSCH 1002c in slot n+3, the K1 value is satisfied (e.g., K1 offset value=2, and the PSSCH occasion is offset by 2 slots), and an ACK/NACK bit for PSSCH 1002c may be included in a feedback message transmitted at PSFCH occasion.

In the example illustrated in FIG. 10, the receiving UE may generate a codebook (e.g., a type-1 HARQ-ACK codebook for sidelink messages) that indicates five ACK and/or NACK bits corresponding a PSSCH occasion of five slots including slot n, slot n+1, slot n+2, slot n+3, and slot n+4. Based on the illustrated PSFCH occasion located one slot in time after slot n+4, each of the K1 values for each slot illustrated in FIG. 10 may be satisfied. Thus, the codebook may indicate an ACK or NACK bit for each of these slots. Where a K1 value for a slot would not have been satisfied, then an ACK or NACK bit for the slot may not be indicated in the codebook to be transmitted in PSFCH occasion 1006.

The receiving UE may transmit an indication of the generated codebook to the transmitting UE. The receiving UE may transmit an indication of the generated codebook in accordance with a sidelink feedback configuration, which may include a PSFCH period (e.g., PSFCH period=N=4) and/or a minimum PSFCH time gap (e.g., denoted as MinTimeGapPSFCH in FIG. 10). Specifically, for the dynamic HARQ timeline, a PSFCH resource pool may be configured with a PSFCH period of N, for purposes of controlling the frequency of transmission/reception switching gaps. For example, in certain aspects, in the sidelink unlicensed (SL-U) band, gaps before and after PSFCH transmissions may break the channel occupancy time (COT). Further, in certain aspects, smaller PSFCH periodicity may be less preferable. Accordingly, setting the PSFCH periodicity may help to define common time resources for all receiving devices to transmit PSFCH.

As illustrated in FIGS. 9 and 10, one benefit of using a dynamic HARQ timeline as opposed to a fixed HARQ timeline is that a transmitter device (e.g., a transmitting UE) may control the frequency of HARQ feedback dynamically. For example, a transmitter device may generate SCI to include large offset values (e.g., large K1 values), such that multiple ACK/NACK bits may be deferred to a later PSFCH transmission. In particular, a transmitter device may generate SCI with large offset values to allow for the transmitter device to schedule multiple PSSCH transmissions prior to receiving a PSFCH with ACK/NACK bits for the multiple PSSCH transmissions (e.g., this may allow the transmitter device to transmit for a long burst of time before needing to receive). This may help to avoid transmission/reception switching in different PSFCH symbols. Further, in some aspects, a transmitter device may transmit a padding PSFCH waveform in PSFCH symbols to maintain the COT.

As mentioned previously, 3GPP Release 16 sidelink has a one-to-one mapping from a slot/subchannel (e.g., a PSSCH occasion) to a particular PSFCH resource (as illustrated in FIG. 6). Thus, a PSFCH resource may include only a single feedback bit for a scheduled PSSCH. However, according to aspects of the present disclosure, multi-bit feedback for multiple PSSCH occasions may be transmitted by a single PSFCH resource. Accordingly, various options, described in detail below, may be used for mapping (e.g., hashing) multiple PSSCH occasions over multiple slots to a particular PSFCH resource and/or particular frequency resources in a particular PSFCH resource.

FIG. 11 is a call flow diagram 1100 illustrating example sidelink signaling for providing multi-bit feedback for multiple PSSCH occasions occurring over multiple time periods in a single PSFCH resource. As shown in call flow diagram 1100, a transmitting UE, UE 104-a, may be in sidelink communication with a receiving UE, UE 104-b. According to aspects described herein, UE 104-a and UE 104-b may support a PSFCH design capable of conveying multi-bit feedback in a single PSFCH resource. Further, UE 104-b may use, or hash to, a PSFCH resource for conveying such multi-bit feedback based on at least one of an ID of UE 104-a or a groupcast ID (e.g., of a group including UE 104-b) associated with one or more of message for which feedback is to be transmitted.

As shown in FIG. 11, at 1102, UE 104-a may transmit sidelink control message(s) to UE 104-b. At 1104, in response to receiving sidelink control message(s) at 1102, UE 104-b may monitor for one or more sidelink data messages over a first subchannel or a first frequency interlace during a specified time period, for example, over multiple slots (e.g., a duration of a number of slots greater than one).

At 1106, UE 104-a may transmit one or more sidelink data messages over the first subchannel or the first frequency interlace during the specified time period. For example, as shown in the example of FIG. 11, UE 104-a may transmit a first sidelink data message to UE 104-b on a first PSSCH resource in a first slot at 1106-1, transmit a second sidelink data message to UE 104-b on a second PSSCH resource in a second slot at 1106-2, and one or more other sidelink data messages (e.g., up to a sidelink data message transmitted at 1106-X) to UE 104-b on different PSSCH resources in different slots during the specified time period. Each of these transmissions may occur over the first subchannel or the first frequency interlace.

UE 104-b may subsequently generate a feedback message indicating ACK/NACK bits associated with the one or more sidelink data messages transmitted (and previously scheduled) by UE 104-a at 1106. In certain aspects, the feedback message may indicate ACK/NACK bits not associated with any sidelink data message.

At 1108, UE 104-b may select one PSFCH resource from a first plurality of PSFCH resources in a first resource pool for transmission of an indication of the generated codebook to UE 104-a. UE 104-b may select the PSFCH resource for transmission of the generated codebook based on at least one of an ID of UE 104-a or a groupcast ID associated with one or more of the sidelink data messages for which feedback is to be transmitted.

At 1110, UE 104-b may transmit, to UE 104-a, an indication of the generated codebook (e.g., a feedback message) in the PSFCH resource selected at 1108. The feedback message may be transmitted over a plurality of RBs of the selected PSFCH resource. In certain aspects, the plurality of RBs may be grouped into a plurality of frequency interlaces (e.g., as illustrated in FIG. 7).

In a first option, RBs or interlaces of a multi-bit PSFCH resource pool may be partitioned based on subchannels or interlaces, respectively. For example, in certain aspects, a multi-bit PSFCH resource pool includes a plurality of frequency interlace groups, where each frequency interlace group contains a plurality of sidelink feedback channel resources. Given this PSFCH resource pool partition into multiple frequency interlace groups, for interlaced PSFCH and PSSCH/PSCCH, one PSSCH interlace may be mapped to one PSFCH interlace. For example, for 80 MHz and a subcarrier spacing (SCS) of 30 KHz, there may be twenty interlaces of PSSCH and PSFCH in a resource pool such that a one-to-one mapping may exist between one PSSCH interlace and one PSFCH interlace. Accordingly, a straight-forward mapping may be provided thereby allowing for mapping from a leading PSSCH interlace X in a RB set Y to a PSFCH interlace X in RB set Y.

For example, in FIG. 11, at 1106, UE 104-b may receive one or more sidelink data messages scheduled over a first frequency interlace. The first frequency interlace may be part of a first frequency interlace group among a plurality of frequency interlace groups in the multi-bit PSFCH resource pool. Accordingly, UE 104-b may select, at 1108, a PSFCH resource, for transmitting ACK/NACK bits for the one or more sidelink data message, from the first frequency interlace group (e.g., where the first frequency interlace group comprises a plurality of PSFCH resources including the selected PSFCH resource).

Alternatively, in certain aspects, a multi-bit PSFCH resource pool may be partitioned into a plurality of RBGs, where each RBG contains a plurality of PSFCH resources. Using this PSFCH resource pool partition, for non-interlaced PSFCH, one PSSCH subchannel may be mapped to one PSFCH RBG. Accordingly, feedback for a PSSCH received over a first subchannel may be transmitted in a PSFCH resource of a PSFCH RBG mapped to the first subchannel.

The size of a PSFCH RBG per subchannel may be defined in accordance with Equation 5,

$${M}_{subch}^{PSFCH} = \frac{{M}_{PRB , set}^{PSFCH}}{{N}_{subch}} \qquad ( 5 )$$

Further, the PSFCH resource pool size may be defined in accordance with Equation 6,

$${R}_{PRB , CS}^{PSFCH} = [ \frac{{M}_{subch}^{PSFCH}}{N} ] \cdot {N}_{CS}^{PSFCH} \cdot {N}_{type}^{PSFCH}$$

where multi-bit PSFCH occupies N PRBs.

For example, in FIG. 11, at 1106, UE 104-b may receive one or more sidelink data messages over a first subchannel. Accordingly, UE 104-b may select, at 1108, a PSFCH resource, for transmitting ACK/NACK bits for the one or more sidelink data message, from an RBG that is selected based on the first subchannel where the one or more sidelink data message are received.

For selecting, or otherwise determining, a resource within the selected RBG, UE 104-b may use hashing and select a PSFCH resource in accordance with a value of (P_{ID}+M_{ID})mod R_{PRB,CS}^{PSFCH}, where, as mentioned previously, P_{ID} may be a physical source ID from SCI, such as second stage SCI (SCI-2), and M_{ID} may be set to 0 or an identity of UE 104-b. For interlaced PSFCH, one RBG contains one interlace, and one interlace has up to six CS pairs for hashing.

The first option described above, for partitioning a multi-bit PSFCH resource pool based on subchannels or interlaces, may be useful where multiple parallel transmissions are occurring, given the first option provides orthogonality (e.g., orthogonal RBGs for each subchannel or interlace). However, in certain aspects, such orthogonality may not be needed.

Instead, in a second option, a multi-bit PSFCH resource pool may include only one RBG or only one frequency interlace group. Accordingly, hashing (e.g., selecting a PSFCH resource) may be based on at least one of an ID of a transmitter of the one or more sidelink data messages or a groupcast ID associated with the one or more sidelink data messages.

In particular, the size of a PSFCH RBG may be defined in accordance with Equation 7,

$${M}_{subch}^{PSFCH} = {M}_{PRB , set}^{PSFCH} PRBs \qquad ( 7 )$$

Further, the PSFCH resource pool size may be defined in accordance with Equation 8,

$${R}_{PRB , CS}^{PSFCH} = [ \frac{{M}_{subch}^{PSFCH}}{N} ] \cdot {N}_{CS}^{PSFCH} \qquad ( 8 )$$

where multi-bit PSFCH occupies N PRBs.

For selecting, or otherwise determining, a PSFCH resource within one RBG, UE 104-b may use hashing and select a PSFCH resource in accordance with a value of (P_{ID}+M_{ID})mod R_{PRB,CS}^{PSFCH}. For example, where only a small number of parallel transmissions are allowed, the leading PSSCH subchannel index or interlace index may be included in the hashing function, for example, (P_{ID}+M_{ID}+h(subch_idx))mod R_{PRB,CS}^{PSFCH}.

In certain aspects, a receiving UE may be scheduled to receive one or more sidelink data messages from a same transmitting UE over multiple PSSCH occasions, where the one or more sidelink data messages comprise a mixture of different casting types. For example, the different casting types may include unicast, groupcast, or broadcast transmissions

As an illustrative example, in addition to the one or more sidelink data messages (e.g., first data message(s)) scheduled and transmitted by UE 104-a, at 806 in FIGS. 8 and 1106 in FIG. 11, one or more other sidelink data messages (e.g., second data message(s)) may also be scheduled and transmitted by UE 104-a to UE 104-b. While the first data message(s) transmitted to UE 104-b, at 806 in FIGS. 8 and 1106 in FIG. 11, may be of a first cast type, for example, unicast, groupcast, or broadcast, the second data message(s) may be of a second cast type that is different from the first cast type. For example, the first data message(s) may be unicast and carry eMBB traffic, while the second data message(s) may be broadcast/groupcast and carry periodic traffic. UE 104-b may need to transmit ACK/NACK feedback for each of the first data message(s) and the second data message(s) having different cast types. Accordingly, certain aspects described herein provide various options for multi-bit feedback for multiple PSSCH occasions associated with different cast types.

In a first option, a same resource pool may be used for selecting PSFCH resources for PSSCH occasions associated with different casting types. For example, PSFCH resources for both the transmission of ACK/NACK bits for groupcast/broadcast PSSCH occasions and the transmission of ACK/NACK bits for unicast PSSCH occasions may be from a same sidelink resource pool. In certain aspects, the sidelink resource pool may be a same multi-bit PSFCH resource pool. In certain aspects, the sidelink resource pool may be two non-overlapping multi-bit PSFCH resource pools. In some cases, the two multi-bit PSFCH resource pools may be frequency division multiplexed (FDMed) (e.g., hard partition in interlaces or PRBs). In some cases, the two multi-bit PSFCH resource pools may be time division multiplexed (TDMed) (e.g., each taking a different slot).

In certain aspects, the first option may be used for SL-U due to its interlaced PSFCH waveform. In this option, even one ACK/NACK bit may need to be transmitted with one PSFCH interlace. In certain aspects, the first option may also be used for cases where both groupcast/broadcast sidelink PSSCH occasions and unicast PSSCH occasions (for which ACK/NACK bits are to be generated and transmitted) carry eMBB traffic.

Further, in some cases, the first option may result in an increase of PSFCH resource collision due to a reduced resource pool size used by the transmission of ACK/NACK bits for both groupcast/broadcast and unicast PSSCH occasions. For example, in SL-U, groupcast receivers may use, or hash to, up to six CS pairs within a PSFCH interlace for ACK/NACK bit feedback. However, with a limited PSFCH resource pool size, there may be an increase in the likelihood of collisions between (1) different ACK/NACK bits for different groupcast/broadcast PSSCH occasions or (2) ACK/NACK bits for groupcast/broadcast sidelink PSSCH occasions and ACK/NACK bits for unicast PSSCH occasions. Accordingly, in certain aspects, to avoid such collisions, a receiver device may multiplex two codebooks (e.g., one codebook containing ACK/NACK bits for groupcast/broadcast PSSCH occasions and one codebook containing ACK/NACK bits for PSSCH occasions) to reduce PSFCH resource collision.

As an illustrative example of the first option using FIG. 8 and FIG. 11, in addition to scheduling one or more sidelink data messages (e.g., first data message(s) in first PSSCH occasion(s)) transmitted by UE 104-a, at 806 in FIGS. 8 and 1106 in FIG. 11, one or more other sidelink data messages (e.g., second data message(s) in second PSSCH occasion(s)) may also be scheduled and transmitted by UE 104-a. The first PSSCH occasion(s) may be associated with unicast transmissions, while the second PSSCH occasion(s) may be associated with groupcast and/or broadcast transmission. In this example, a PSFCH resource used for the transmission of a first sidelink feedback message associated with the first PSSCH occasion(s) may be selected from a first resource pool. Further, a PSFCH resource used for the transmission of a second sidelink feedback message associated with the second PSSCH occasion(s) may be selected from a second resource pool. According to the first option, the PSFCH resources of the first resource pool may be FDMed or TDMed with PSFCH resources of the second resource pool.

In a second option, different resource pools may be used for selecting PSFCH resources for PSSCH occasions associated with different casting types. For example, PSFCH resources used for the transmission of ACK/NACK bits for groupcast/broadcast PSSCH occasions and PSFCH resources used for the transmission of ACK/NACK bits for unicast PSSCH occasions may not belong to the same sidelink resource pool.

In certain aspects, the transmission of ACK/NACK bits for groupcast/broadcast PSSCH occasions may use a single-bit PSFCH resource pool, while the transmission of ACK/NACK bits for unicast PSSCH occasions may use the multi-bit PSFCH resource pool. In other words, a sidelink feedback message associated with the groupcast/broadcast PSSCH occasions may indicate only a single-bit. In certain aspects, the single-bit PSFCH resource pool (e.g., with non-interlaced PSFCH waveform) may be multiplexed with the multi-bit PSFCH resource pool.

FIG. 12 illustrates the single-bit PSFCH resource pool (e.g., 1-bit PSFCH resource pool) FDMed with the multi-bit PSFCH resource pool. As shown in FIG. 12, where the resource pools are FDMed, each of the resource pools may include different PRBs.

FIG. 13 illustrates the single-bit PSFCH resource pool TDMed with the multi-bit PSFCH resource pool. As shown in FIG. 13, where the resource pools are TDMed, each of the resource pools may use different slots with different resource pool offset and periodicity.

It is to be noted, however, that for SL-U, in some cases, the second option described herein may not be possible given interlaced PSFCH may be needed for providing feedback for groupcast/broadcast PSSCH occasions, and the single-bit PSFCH resource pool includes a noninterlaced PSFCH waveform. Further, the introduction of the multi-bit PSFCH resource pool in addition to the single-bit resource pool may cause the PSFCH resource pool size to be reduced thereby causing an increase in resource collision probability.

In summary, using either the first option or the second option described above, a receiver device needing to feed back ACK/NACK bits for both groupcast/broadcast PSSCH occasions and unicast PSSCH occasions may select separate PSFCH resources for transmission. However, for the first option, each PSFCH resource may be selected from a same or different multi-bit PSFCH resource pool, while for the second option, a PSFCH resource for transmission of ACK/NACK bits for groupcast/broadcast PSSCH occasions may be selected from the single-bit PSFCH resource pool (e.g., 1-bit PSFCH resource pool).

In a third option, where ACK/NACK bits for groupcast/broadcast PSSCH occasions and ACK/NACK bits for unicast PSSCH occasions are to be transmitted back to a transmitter device (e.g., which transmitted such messages) in a same PSFCH occasion, the ACK/NACK bits for the groupcast/broadcast PSSCH occasions may be concatenated with the ACK/NACK bits for the unicast PSSCH occasions and transmitted together using a multi-bit unicast PSFCH resource. In other words, ACK/NACK bits for the groupcast/broadcast PSSCH occasions may piggyback on the multi-bit unicast PSFCH resource. In this case, the PSFCH resource is determined by the unicast PSSCH occasions, and the groupcast/broadcast PSFCH resource is cancelled.

As an illustrative example of the third option using FIG. 8 and FIG. 11, in addition to scheduling the one or more sidelink data messages (e.g., first data message(s) in first PSSCH occasion(s)) transmitted by UE 104-a, at 806 in FIGS. 8 and 1106 in FIG. 11, one or more other sidelink data messages (e.g., second data message(s) in second PSSCH occasion(s)) may be scheduled. The first PSSCH occasion(s) may be associated with unicast transmissions, while the second PSSCH occasion(s) may be associated with groupcast or broadcast transmission. In this example, a PSFCH resource used for the transmission of feedback bits for the first PSSCH occasion(s) may also indicate one or more other feedback bits associated with the second PSSCH occasion(s). This may occur where the first PSSCH occasion(s) and the PSSCH occasion(s) are associated with a same PSFCH occasion.

In certain aspects, the third option may be used to reduce PSFCH resource collision. For example, where ACK/NACK bits for groupcast/broadcast PSSCH occasions use a different resource pool than ACK/NACK bits for unicast PSSCH occasions, using the third option, a receiver device may be able to reduce collisions between different ACK/NACK bits for different groupcast/broadcast PSSCH occasions. As another example, where ACK/NACK bits for groupcast/broadcast PSSCH occasions use a same resource pool as ACK/NACK bits for unicast PSSCH occasions, using the third option, a receiver device may be able to reduce collisions between the ACK/NACK bits for groupcast/broadcast PSSCH occasions and ACK/NACK bits for unicast PSSCH occasions.

In certain aspects, RRC signaling may be used to switch between each of the three options described in detail above.

In certain aspects, the concatenated payload (e.g., ACK/NACK bits for the groupcast/broadcast PSSCH occasions concatenated with ACK/NACK bits for the unicast PSSCH occasions) may exceed a multi-bit PSFCH capacity. Accordingly, a receiver device scheduled to receive PSSCHs in each of these PSSCH occasions, may determine to use one of the first option or the second option described above. As described above, using either the first option or the second option described above, a receiver device needing to feed back ACK/NACK bits for both groupcast/broadcast PSSCH occasions and unicast PSSCH occasions may select separate PSFCH resources for transmission. However, for the first option, each PSFCH resource may be selected from a same or different multi-bit PSFCH, while for the second option, a PSFCH resource for transmission of ACK/NACK bits for groupcast/broadcast PSSCH occasions may be selected only from the single-bit PSFCH resource pool (e.g., 1-bit PSFCH resource pool).

Alternatively, where the concatenated payload exceeds the multi-bit PSFCH capacity, a receiver device may determine to transmit less than all of the ACK/NACK bits to be concatenated in the payload. For example, in certain aspects, the PSFCH payload may be filled with ACK/NACK bits associated with groupcast/broadcast sidelink PSSCH occasions first, and where additional capacity remains, may be subsequently filled with ACK/NACK bits associated with unicast PSSCH occasions until capacity is reached (e.g., less than all ACK/NACK bits associated with unicast PSSCH occasions may be included in the concatenated payload). In certain other aspects, the PSFCH payload may be filled with ACK/NACK bits associated with unicast PSSCH occasions first, and where additional capacity remains, may be subsequently filled with ACK/NACK bits associated with groupcast/broadcast PSSCH occasions until capacity is reached (e.g., less than all ACK/NACK bits for groupcast/broadcast PSSCH occasions may be included in the concatenated payload).

In certain aspects (e.g., where a concatenated payload of all ACK/NACK bits exceeds the multi-bit PSFCH capacity), ACK/NACK bits which are to be included in the PSFCH payload may be based on a priority of the unicast PSSCH occasions and a priority of the groupcast/broadcast PSSCH occasions, which may be based on a priority of a sidelink data message in a PSSCH occasion, such as indicated in a PSCCH scheduling the sidelink data message.

For example, in certain aspects, which of the PSSCH occasions do not have feedback bits indicated in the feedback message may be based on a priority of the unicast PSSCH occasions and a priority of the groupcast/broadcast PSSCH occasions. In other words, a priority for the codebook indicating ACK/NACK bits for groupcast/broadcast PSSCH occasions may be compared with a priority for the codebook indicating ACK/NACK bits for unicast PSSCH occasions, and based on this comparison, the codebook with the higher priority may be used to fill the PSFCH payload. Where additional capacity remains in the payload after filling the payload with ACK/NACK bits from the higher priority codebook, the remaining capacity may be filled with ACK/NACK bits from the lower priority codebook.

In certain other aspects, which of the sidelink data messages do not have feedback bits indicated in the feedback message may be based on a priority of each of the the unicast PSSCH occasions and a priority of the groupcast/broadcast PSSCH occasions.

In certain other aspects, which of the PSSCH occasions do not have feedback bits indicated in the feedback message may be based on a size of each codebook. In other words, a size of the codebook containing ACK/NACK bits for groupcast/broadcast PSSCH occasions may be compared with a size of the codebook containing ACK/NACK bits for unicast PSSCH occasions, and based on this comparison, the codebook with the smaller or larger size may be used to first fill the PSFCH payload. Where additional capacity remains in the payload after filling the payload with ACK/NACK bits from the smaller or larger size codebook, the remaining capacity may be filled with ACK/NACK bits from the other larger or smaller size codebook.

### Example Operations of a User Equipment

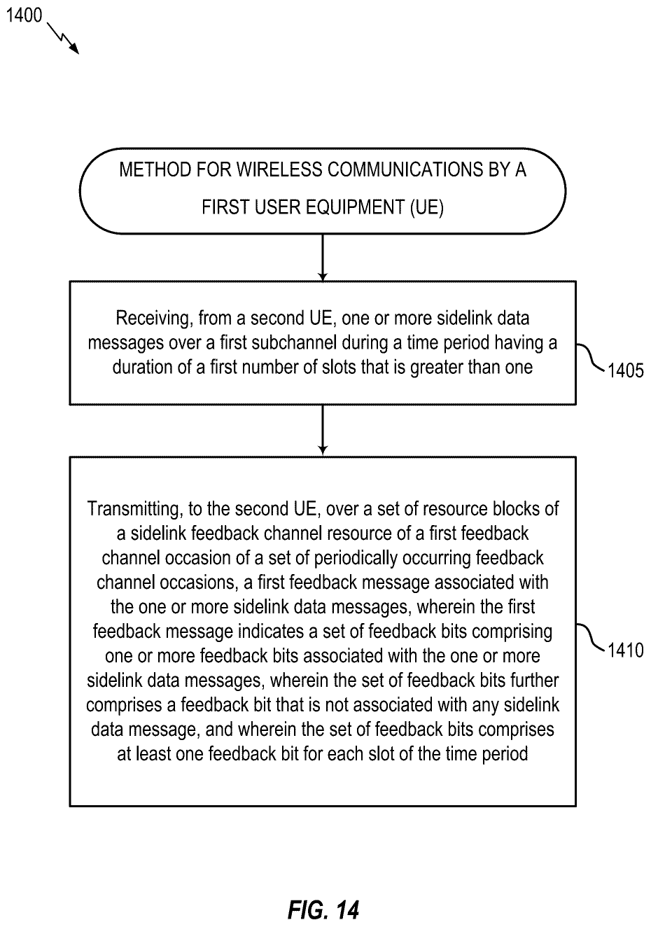

FIG. 14 shows a method 1400 for wireless communications by a first UE, such as UE 104 of FIGS. 1 and 3.

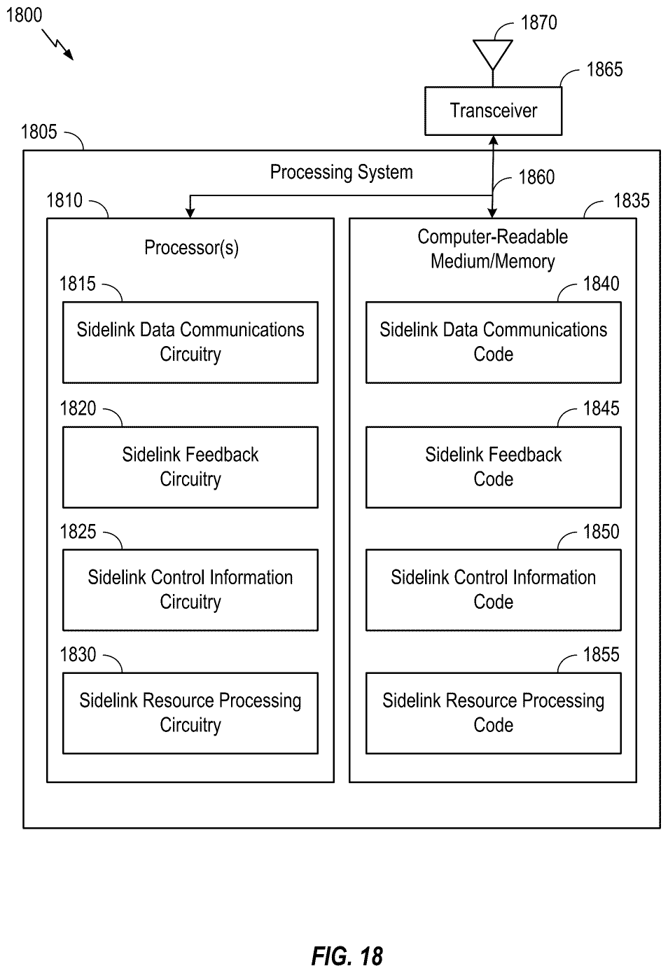

Method 1400 begins at 1405 with receiving, from a second UE, one or more sidelink data messages over a first subchannel during a time period having a duration of a first number of slots that is greater than one. In some cases, the operations of this step refer to, or may be performed by, sidelink data communications circuitry as described with reference to FIG. 18.

Method 1400 then proceeds to step 1410 with transmitting, to the second UE, over a set of resource blocks of a sidelink feedback channel resource of a first feedback channel occasion of a set of periodically occurring feedback channel occasions, a first feedback message associated with the one or more sidelink data messages, wherein the first feedback message indicates a set of feedback bits comprising one or more feedback bits associated with the one or more sidelink data messages, wherein the set of feedback bits further comprises a feedback bit that is not associated with any sidelink data message, and wherein the set of feedback bits comprises at least one feedback bit for each slot of the time period. In some cases, the operations of this step refer to, or may be performed by, sidelink data communications circuitry as described with reference to FIG. 18.

Various aspects relate to the method 1400, including the following aspects.

In some aspects, each of the plurality of feedback bits indicates a corresponding ACK or a corresponding NACK. In some aspects, the feedback bit that is not associated with any sidelink data message indicates a NACK.

In some aspects, the method 1400 further includes receiving, from a third UE, one or more other sidelink data messages over the first subchannel during the time period. In some aspects, the method 1400 further includes transmitting, to the third UE, over a second plurality of resource blocks of a second sidelink feedback channel resource, a second feedback message associated with the one or more other sidelink data messages, wherein the second feedback message indicates a second plurality of feedback bits comprising one or more other feedback bits associated with the one or more other sidelink data messages, and wherein the second plurality of feedback bits comprises at least one feedback bit for each slot of the time period.

In some aspects, for each slot of the time period, the corresponding at least one feedback bit of the plurality of feedback bits comprises multiple feedback bits corresponding to a plurality of spatial layers.

In some aspects, the method 1400 further includes receiving, from the second UE, one or more other sidelink data messages over a second subchannel during the time period. In some aspects, the method 1400 further includes transmitting, to the second UE, over a second plurality of resource blocks of a second sidelink feedback channel resource, a second feedback message associated with the one or more other sidelink data messages, wherein the second feedback message indicates a second plurality of feedback bits comprising one or more other feedback bits associated with the one or more other sidelink data messages, and wherein the second plurality of feedback bits comprises at least one feedback bit for each slot of the time period.

In some aspects, the set has a periodicity of the first number of slots.

In some aspects, the method 1400 further includes receiving, from the second UE, for each of the one or more sidelink data messages, a corresponding sidelink control information indicating a corresponding offset value defining a duration between reception of the one or more sidelink data messages and transmission of the first feedback message, wherein the corresponding offset value is one of a number of defined offset values, and wherein the first number of slots is equal to the number of defined offset values.

In one aspect, the method 1400, or any aspect related to it, may be performed by an apparatus, such as communications device 1800 of FIG. 18, which includes various components operable, configured, or adapted to perform the method 1400. Communications device 1800 is described below in further detail.

Note that FIG. 14 is just one example of a method, and other methods including fewer, additional, or alternative steps are possible consistent with this disclosure.

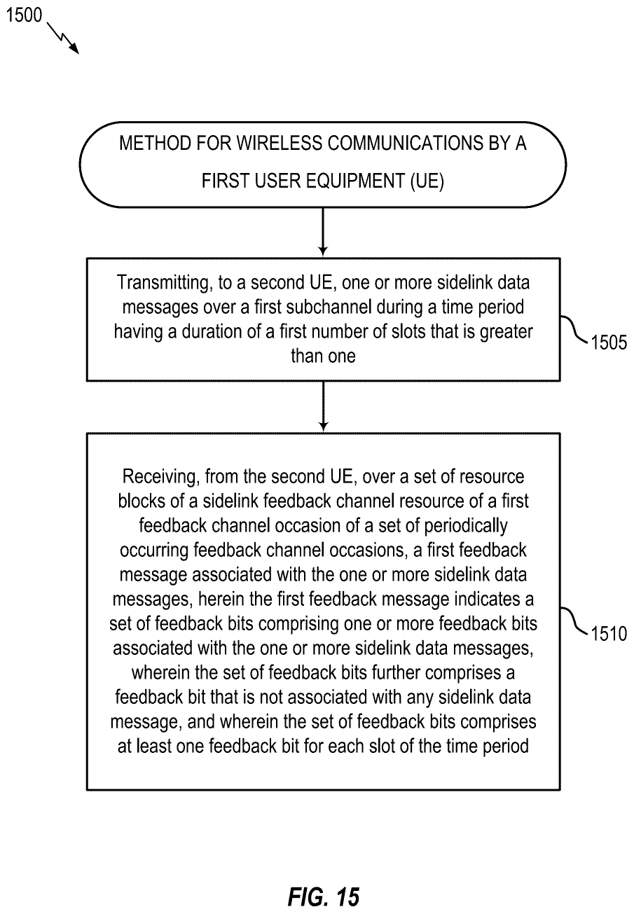

FIG. 15 shows a method 1500 for wireless communications by a first UE, such as UE 104 of FIGS. 1 and 3.

Method 1500 begins at 1505 with transmitting, to a second UE, one or more sidelink data messages over a first subchannel during a time period having a duration of a first number of slots that is greater than one. In some cases, the operations of this step refer to, or may be performed by, sidelink feedback circuitry as described with reference to FIG. 18.

Method 1500 then proceeds to step 1510 with receiving, from the second UE, over a set of resource blocks of a sidelink feedback channel resource of a first feedback channel occasion of a set of periodically occurring feedback channel occasions, a first feedback message associated with the one or more sidelink data messages, wherein the first feedback message indicates a set of feedback bits comprising one or more feedback bits associated with the one or more sidelink data messages, wherein the set of feedback bits further comprises a feedback bit that is not associated with any sidelink data message, and wherein the set of feedback bits comprises at least one feedback bit for each slot of the time period. In some cases, the operations of this step refer to, or may be performed by, sidelink feedback circuitry as described with reference to FIG. 18.

Various aspects relate to the method 1500, including the following aspects.

In some aspects, each of the plurality of feedback bits indicates a corresponding ACK or a corresponding NACK. In some aspects, the feedback bit that is not associated with any sidelink data message indicates a NACK.

In some aspects, for each slot of the time period, the corresponding at least one feedback bit of the plurality of feedback bits comprises multiple feedback bits corresponding to a plurality of spatial layers.

In some aspects, the method 1500 further includes transmitting, to the second UE, one or more other sidelink data messages over a second subchannel during the time period. In some aspects, the method 1500 further includes receiving, from the second UE, over a second plurality of resource blocks of a second sidelink feedback channel resource, a second feedback message associated with the one or more other sidelink data messages, wherein the second feedback message indicates a second plurality of feedback bits comprising one or more other feedback bits associated with the one or more other sidelink data messages, and wherein the second plurality of feedback bits comprises at least one feedback bit for each slot of the time period.

In some aspects, the set has a periodicity of the first number of slots.

In some aspects, the method 1500 further includes transmitting, to the second UE, for each of the one or more sidelink data messages, a corresponding sidelink control information indicating a corresponding offset value defining a duration between reception of the one or more sidelink data messages and transmission of the first feedback message, wherein the corresponding offset value is one of a number of defined offset values, and wherein the first number of slots is equal to the number of defined offset values.

In one aspect, the method 1500, or any aspect related to it, may be performed by an apparatus, such as communications device 1800 of FIG. 18, which includes various components operable, configured, or adapted to perform the method 1500. Communications device 1800 is described below in further detail.

Note that FIG. 15 is just one example of a method, and other methods including fewer, additional, or alternative steps are possible consistent with this disclosure.

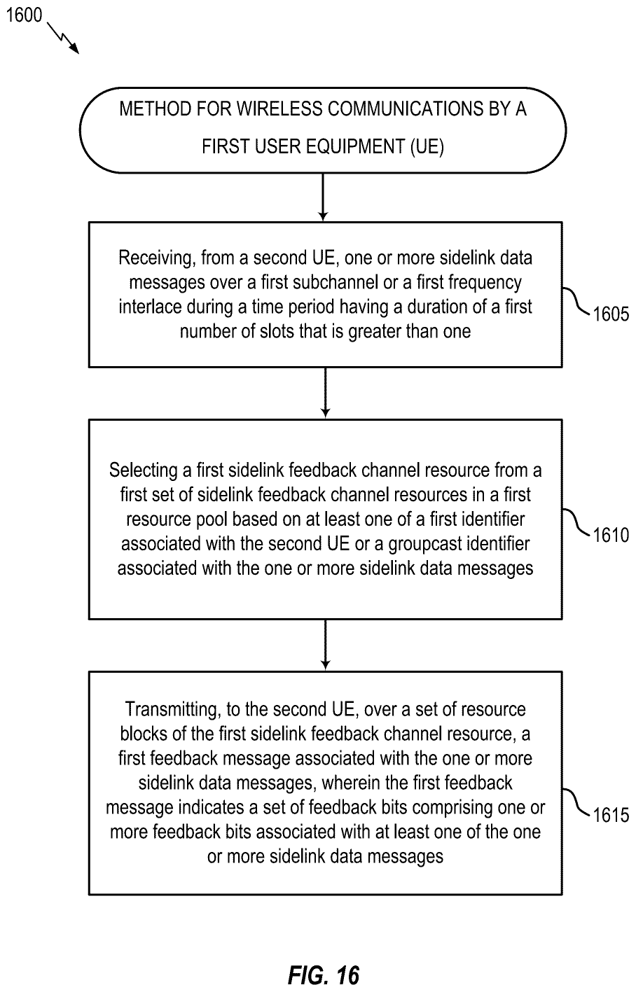

FIG. 16 shows a method 1600 for wireless communications by a first UE, such as UE 104 of FIGS. 1 and 3.

Method 1600 begins at 1605 with receiving, from a second UE, one or more sidelink data messages over a first subchannel or a first frequency interlace during a time period having a duration of a first number of slots that is greater than one. In some cases, the operations of this step refer to, or may be performed by, sidelink control information circuitry as described with reference to FIG. 18.

Method 1600 then proceeds to step 1610 with selecting a first sidelink feedback channel resource from a first set of sidelink feedback channel resources in a first resource pool based on at least one of a first identifier associated with the second UE or a groupcast identifier associated with the one or more sidelink data messages. In some cases, the operations of this step refer to, or may be performed by, sidelink control information circuitry as described with reference to FIG. 18.

Method 1600 then proceeds to step 1615 with transmitting, to the second UE, over a set of resource blocks of the first sidelink feedback channel resource, a first feedback message associated with the one or more sidelink data messages, wherein the first feedback message indicates a set of feedback bits comprising one or more feedback bits associated with at least one of the one or more sidelink data messages. In some cases, the operations of this step refer to, or may be performed by, sidelink control information circuitry as described with reference to FIG. 18.

Various aspects relate to the method 1600, including the following aspects.

In some aspects, the one or more sidelink data messages are received over the first frequency interlace, the first resource pool comprises a plurality of frequency interlace groups, each of the plurality of frequency interlace groups comprises a plurality of sidelink feedback channel resources, the plurality of frequency interlace groups comprise a first frequency interlace group comprising the first plurality of sidelink feedback channel resources, and the method 1600 further comprises selecting the first frequency interlace group based on the first frequency interlace.

In some aspects, the first frequency interlace group comprises the first frequency interlace.

In some aspects, the one or more sidelink data messages are received over the first subchannel, the first resource pool comprises a plurality of resource block groups, each of the plurality of resource block groups comprises a plurality of sidelink feedback channel resources, the plurality of resource block groups comprise a first resource block group comprising the first plurality of sidelink feedback channel resources, and the method 1600 further comprises: selecting the first resource block group based on the first subchannel.

In some aspects, the first resource pool includes only one resource block group or one frequency interlace group.

In some aspects, the method 1600 further includes receiving, from the second UE, one or more other sidelink data messages, wherein the one or more sidelink data messages are one or more unicast sidelink data messages, and wherein the one or more other sidelink data messages are at least one of one or more groupcast sidelink data messages or one or more broadcast sidelink data messages. In some aspects, the method 1600 further includes selecting a second sidelink feedback channel resource from the first resource pool. In some aspects, the method 1600 further includes transmitting, to the second UE, over a second plurality of resource blocks of the second sidelink feedback channel resource, a second feedback message associated with the one or more other sidelink data messages, wherein the second feedback message indicates a second plurality of feedback bits comprising one or more other feedback bits associated with at least one of the one or more other sidelink data messages.

In some aspects, the method 1600 further includes receiving, from the second UE, one or more other sidelink data messages, wherein the one or more sidelink data messages are one or more unicast sidelink data messages, and wherein the one or more other sidelink data messages are at least one of one or more groupcast sidelink data messages or one or more broadcast sidelink data messages. In some aspects, the method 1600 further includes selecting a second sidelink feedback channel resource from a second resource pool. In some aspects, the method 1600 further includes transmitting, to the second UE, a second feedback message associated with at least one of the one or more other sidelink data messages.

In some aspects, the sidelink feedback channel resources of the first resource pool are frequency division multiplexed with sidelink feedback channel resources of the second resource pool. In some aspects, the sidelink feedback channel resources of the first resource pool are time division multiplexed with sidelink feedback channel resources of the second resource pool.

In some aspects, the second feedback message indicates a second plurality of feedback bits comprising one or more other feedback bits associated with at least one of the one or more other sidelink data messages. In some aspects, the second feedback message indicates only a single-bit.

In some aspects, the method 1600 further includes receiving, from the second UE, one or more other sidelink data messages, wherein the one or more sidelink data messages are one or more unicast sidelink data messages, wherein the one or more other sidelink data messages are at least one of one or more groupcast sidelink data messages or one or more broadcast sidelink data messages, wherein the first feedback message further indicates one or more other feedback bits associated with at least one of the one or more other sidelink data messages based on the one or more sidelink data messages and the one or more other sidelink data messages being associated with a same feedback channel occasion.

In some aspects, the first feedback message indicates feedback bits for less than all of the one or more sidelink data messages or the one or more other sidelink data messages. In some aspects, which of the one or more sidelink data messages or the one or more other sidelink data messages do not have feedback bits indicated in the first feedback message is based on a priority of unicast sidelink data messages and a priority of groupcast or broadcast sidelink messages.

In some aspects, which of the one or more sidelink data messages or the one or more other sidelink data messages do not have feedback bits indicated in the first feedback message is based on a priority of each of the one or more sidelink data messages and the one or more other sidelink data messages.

In one aspect, the method 1600, or any aspect related to it, may be performed by an apparatus, such as communications device 1800 of FIG. 18, which includes various components operable, configured, or adapted to perform the method 1600. Communications device 1800 is described below in further detail.

Note that FIG. 16 is just one example of a method, and other methods including fewer, additional, or alternative steps are possible consistent with this disclosure.

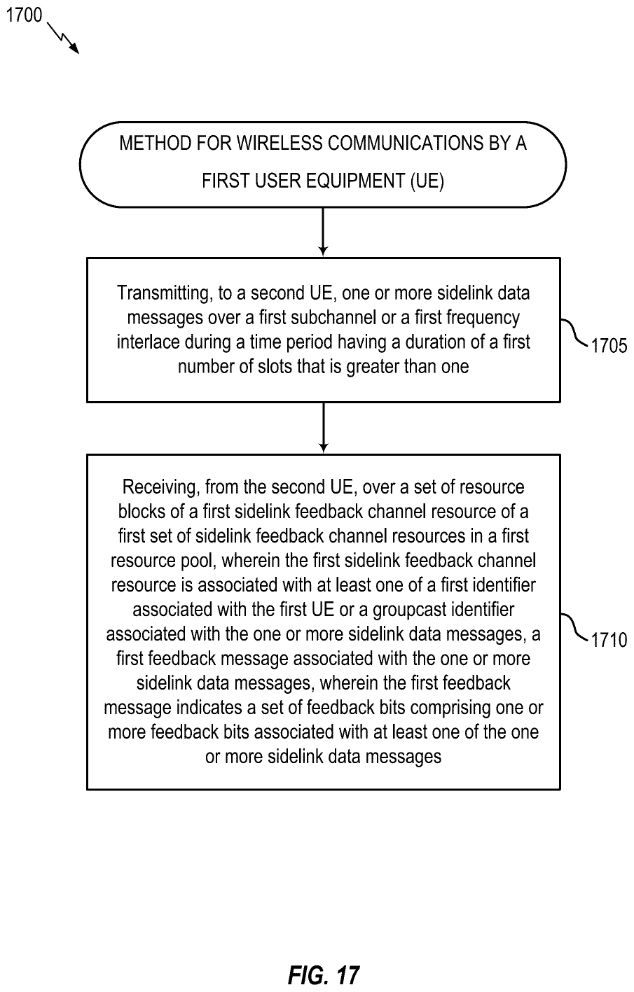

FIG. 17 shows a method 1700 for wireless communications by a first UE, such as UE 104 of FIGS. 1 and 3.

Method 1700 begins at 1705 with transmitting, to a second UE, one or more sidelink data messages over a first subchannel or a first frequency interlace during a time period having a duration of a first number of slots that is greater than one. In some cases, the operations of this step refer to, or may be performed by, sidelink resource processing circuitry as described with reference to FIG. 18.

Method 1700 then proceeds to step 1710 with receiving, from the second UE, over a set of resource blocks of a first sidelink feedback channel resource of a first set of sidelink feedback channel resources in a first resource pool, wherein the first sidelink feedback channel resource is associated with at least one of a first identifier associated with the first UE or a groupcast identifier associated with the one or more sidelink data messages, a first feedback message associated with the one or more sidelink data messages, wherein the first feedback message indicates a set of feedback bits comprising one or more feedback bits associated with at least one of the one or more sidelink data messages. In some cases, the operations of this step refer to, or may be performed by, sidelink resource processing circuitry as described with reference to FIG. 18.

Various aspects relate to the method 1700, including the following aspects.

In some aspects, the one or more sidelink data messages are transmitted over the first frequency interlace, the first resource pool comprises a plurality of frequency interlace groups, each of the plurality of frequency interlace groups comprises a plurality of sidelink feedback channel resources, the plurality of frequency interlace groups comprise a first frequency interlace group comprising the first plurality of sidelink feedback channel resources, and the first frequency interlace group is associated with the first frequency interlace.

In some aspects, the first frequency interlace group comprises the first frequency interlace.

In some aspects, the one or more sidelink data messages are received over the first subchannel, the first resource pool comprises a plurality of resource block groups, each of the plurality of resource block groups comprises a plurality of sidelink feedback channel resources, the plurality of resource block groups comprise a first resource block group comprising the first plurality of sidelink feedback channel resources, and the first resource block group is associated with the first subchannel.

In some aspects, the first resource pool includes only one resource block group or one frequency interlace group.

In some aspects, the method 1700 further includes transmitting, to the second UE, one or more other sidelink data messages, wherein the one or more sidelink data messages are one or more unicast sidelink data messages, and wherein the one or more other sidelink data messages are at least one of one or more groupcast sidelink data messages or one or more broadcast sidelink data messages. In some aspects, the method 1700 further includes receiving, from the second UE, over a second plurality of resource blocks of a second sidelink feedback channel resource of the first resource pool, a second feedback message associated with the one or more other sidelink data messages, wherein the second feedback message indicates a second plurality of feedback bits comprising one or more feedback bits associated with at least one of the one or more other sidelink data messages.

In some aspects, the method 1700 further includes transmitting, to the second UE, one or more other sidelink data messages, wherein the one or more sidelink data messages are one or more unicast sidelink data messages, and wherein the one or more other sidelink data messages are at least one of one or more groupcast sidelink data messages or one or more broadcast sidelink data messages. In some aspects, the method 1700 further includes receiving, from the second UE, a second feedback message associated with at least one of the one or more other sidelink data messages.

In some aspects, the sidelink feedback channel resources of the first resource pool are frequency division multiplexed with sidelink feedback channel resources of a second resource pool. In some aspects, the sidelink feedback channel resources of the first resource pool are time division multiplexed with sidelink feedback channel resources of a second resource pool.

In some aspects, the second feedback message indicates a second plurality of feedback bits associated with at least one of the one or more other sidelink data messages. In some aspects, the second feedback message indicates only a single-bit.

In some aspects, the method 1700 further includes transmitting, to the second UE, one or more other sidelink data messages, wherein the one or more sidelink data messages are one or more unicast sidelink data messages, wherein the one or more other sidelink data messages are at least one of one or more groupcast sidelink data messages or one or more broadcast sidelink data messages, wherein the first feedback message further indicates one or more feedback bits associated with at least one of the one or more other sidelink data messages based on the one or more sidelink data messages and the one or more other sidelink data messages being associated with a same feedback channel occasion.

In some aspects, the first feedback message indicates feedback bits for less than all of the one or more sidelink data messages or the one or more other sidelink data messages. In some aspects, which of the one or more sidelink data messages or the one or more other sidelink data messages do not have feedback bits indicated in the first feedback message is based on a priority of unicast sidelink data messages and a priority of groupcast or broadcast sidelink messages.

In some aspects, which of the one or more sidelink data messages or the one or more other sidelink data messages do not have feedback bits indicated in the first feedback message is based on a priority of each of the one or more sidelink data messages and the one or more other sidelink data messages.

In one aspect, the method 1700, or any aspect related to it, may be performed by an apparatus, such as communications device 1800 of FIG. 18, which includes various components operable, configured, or adapted to perform the method 1700. Communications device 1800 is described below in further detail.

Note that FIG. 17 is just one example of a method, and other methods including fewer, additional, or alternative steps are possible consistent with this disclosure.

### Example Communications Device

FIG. 18 depicts aspects of an example communications device 1800. In some aspects, communications device 1800 is a user equipment, such as UE 104 described above with respect to FIGS. 1 and 3.

The communications device 1800 includes a processing system 1805 coupled to the transceiver 1865 (e.g., a transmitter and/or a receiver). The transceiver 1865 is configured to transmit and receive signals for the communications device 1800 via the antenna 1870, such as the various signals as described herein. The processing system 1805 may be configured to perform processing functions for the communications device 1800, including processing signals received and/or to be transmitted by the communications device 1800.

The processing system 1805 includes one or more processors 1810. In various aspects, the one or more processors 1810 may be representative of one or more of receive processor 358, transmit processor 364, TX MIMO processor 366, and/or controller/processor 380, as described with respect to FIG. 3. The one or more processors 1810 are coupled to a computer-readable medium/memory 1835 via a bus 1860. In certain aspects, the computer-readable medium/memory 1835 is configured to store instructions (e.g., computer-executable code) that when executed by the one or more processors 1810, cause the one or more processors 1810 to perform the method 1400 described with respect to FIG. 14 (or any aspect related to it), the method 1500 described with respect to FIG. 15 (or any aspect related to it), the method 1600 described with respect to FIG. 16 (or any aspect related to it), and the method 1700 described with respect to FIG. 17 (or any aspect related to it). Note that reference to a processor performing a function of communications device 1800 may include one or more processors 1810 performing that function of communications device 1800.

In the depicted example, computer-readable medium/memory 1835 stores code (e.g., executable instructions), such as sidelink data communications code 1840, sidelink feedback code 1845, sidelink control information code 1850, and sidelink resource processing code 1855. Processing of the sidelink data communications code 1840, sidelink feedback code 1845, sidelink control information code 1850, and sidelink resource processing code 1855 may cause the communications device 1800 to perform the method 1400 described with respect to FIG. 14 (or any aspect related to it), the method 1500 described with respect to FIG. 15 (or any aspect related to it), the method 1600 described with respect to FIG. 16 (or any aspect related to it), and the method 1700 described with respect to FIG. 17 (or any aspect related to it).

The one or more processors 1810 include circuitry configured to implement (e.g., execute) the code stored in the computer-readable medium/memory 1835, including circuitry such as sidelink data communications circuitry 1815, sidelink feedback circuitry 1820, sidelink control information circuitry 1825, and sidelink resource processing circuitry 1830. Processing with sidelink data communications circuitry 1815, sidelink feedback circuitry 1820, sidelink control information circuitry 1825, and sidelink resource processing circuitry 1830 may cause the communications device 1800 to perform the method 1400 described with respect to FIG. 14 (or any aspect related to it), the method 1500 described with respect to FIG. 15 (or any aspect related to it), the method 1600 described with respect to FIG. 16 (or any aspect related to it), and the method 1700 described with respect to FIG. 17 (or any aspect related to it).

Various components of the communications device 1800 may provide means for performing the method 1400 described with respect to FIG. 14 (or any aspect related to it), the method 1500 described with respect to FIG. 15 (or any aspect related to it), the method 1600 described with respect to FIG. 16 (or any aspect related to it), and the method 1700 described with respect to FIG. 17 (or any aspect related to it). For example, means for transmitting, sending or outputting for transmission may include transceivers 354 and/or antenna(s) 352 of the UE 104 illustrated in FIG. 3 and/or the transceiver 1865 and the antenna 1870 of the communications device 1800 in FIG. 18. Means for receiving or obtaining may include transceivers 354 and/or antenna(s) 352 of the UE 104 illustrated in FIG. 3 and/or the transceiver 1865 and the antenna 1870 of the communications device 1800 in FIG. 18.

According to some aspects, the communications device 1800 is a first UE (e.g., a receiving UE) and may perform the method 1400 where sidelink data communications circuitry 1815 receives, from a second UE, one or more sidelink data messages over a first subchannel during a time period having a duration of a first number of slots that is greater than one. Further, sidelink feedback circuitry 1820 transmits, to the second UE, over a set of resource blocks of a sidelink feedback channel resource of a first feedback channel occasion of a set of periodically occurring feedback channel occasions, a first feedback message associated with the one or more sidelink data messages, wherein the first feedback message indicates a set of feedback bits comprising one or more feedback bits associated with the one or more sidelink data messages, wherein the set of feedback bits further comprises a feedback bit that is not associated with any sidelink data message, and wherein the set of feedback bits comprises at least one feedback bit for each slot of the time period.

According to some aspects, the communications device 1800 is a first UE (e.g., a transmitting UE) and may perform the method 1500 where sidelink data communications circuitry 1815 transmits, to a second UE, one or more sidelink data messages over a first subchannel during a time period having a duration of a first number of slots that is greater than one. Further, sidelink feedback circuitry 1820 receives, from the second UE, over a set of resource blocks of a sidelink feedback channel resource of a first feedback channel occasion of a set of periodically occurring feedback channel occasions, a first feedback message associated with the one or more sidelink data messages, wherein the first feedback message indicates a set of feedback bits comprising one or more feedback bits associated with the one or more sidelink data messages, wherein the set of feedback bits further comprises a feedback bit that is not associated with any sidelink data message, and wherein the set of feedback bits comprises at least one feedback bit for each slot of the time period.

According to some aspects, the communications device 1800 is a first UE (e.g., a receiving UE) and may perform the method 1600 where sidelink data communications circuitry 1815 receives, from a second UE, one or more sidelink data messages over a first subchannel or a first frequency interlace during a time period having a duration of a first number of slots that is greater than one. Further, sidelink resource processing circuitry 1830 selects a first sidelink feedback channel resource from a first set of sidelink feedback channel resources in a first resource pool based on at least one of a first identifier associated with the second UE or a groupcast identifier associated with the one or more sidelink data messages. Further, sidelink feedback circuitry 1820 transmits, to the second UE, over a set of resource blocks of the first sidelink feedback channel resource, a first feedback message associated with the one or more sidelink data messages, wherein the first feedback message indicates a set of feedback bits comprising one or more feedback bits associated with at least one of the one or more sidelink data messages.

According to some aspects, the communications device 1800 is a first UE (e.g., a transmitting UE) and may perform the method 1700 where sidelink data communications circuitry 1815 transmits, to a second UE, one or more sidelink data messages over a first subchannel or a first frequency interlace during a time period having a duration of a first number of slots that is greater than one. Further, sidelink feedback circuitry 1820 receives, from the second UE, over a set of resource blocks of a first sidelink feedback channel resource of a first set of sidelink feedback channel resources in a first resource pool, wherein the first sidelink feedback channel resource is associated with at least one of a first identifier associated with the first UE or a groupcast identifier associated with the one or more sidelink data messages, a first feedback message associated with the one or more sidelink data messages, wherein the first feedback message indicates a set of feedback bits comprising one or more feedback bits associated with at least one of the one or more sidelink data messages.

### Example Clauses

Implementation examples are described in the following numbered clauses:

Clause 1: A method for wireless communications by a first UE, the method comprising: receiving, from a second UE, one or more sidelink data messages over a first subchannel during a time period having a duration of a first number of slots that is greater than one; and transmitting, to the second UE, over a plurality of resource blocks of a sidelink feedback channel resource of a first feedback channel occasion of a set of periodically occurring feedback channel occasions, a first feedback message associated with the one or more sidelink data messages, wherein the first feedback message indicates a plurality of feedback bits comprising one or more feedback bits associated with the one or more sidelink data messages, wherein the plurality of feedback bits further comprises a feedback bit that is not associated with any sidelink data message, and wherein the plurality of feedback bits comprises at least one feedback bit for each slot of the time period.

Clause 2: The method of Clause 1, wherein each of the plurality of feedback bits indicates a corresponding ACK or a corresponding NACK.

Clause 3: The method of Clause 2, wherein the feedback bit that is not associated with any sidelink data message indicates a NACK.

Clause 4: The method of any one of Clauses 1-3, further comprising: receiving, from a third UE, one or more other sidelink data messages over the first subchannel during the time period; and transmitting, to the third UE, over a second plurality of resource blocks of a second sidelink feedback channel resource, a second feedback message associated with the one or more other sidelink data messages, wherein the second feedback message indicates a second plurality of feedback bits comprising one or more other feedback bits associated with the one or more other sidelink data messages, and wherein the second plurality of feedback bits comprises at least one feedback bit for each slot of the time period.

Clause 5: The method of any one of Clauses 1-4, wherein, for each slot of the time period, the corresponding at least one feedback bit of the plurality of feedback bits comprises multiple feedback bits corresponding to a plurality of spatial layers.

Clause 6: The method of any one of Clauses 1-5, further comprising: receiving, from the second UE, one or more other sidelink data messages over a second subchannel during the time period; and transmitting, to the second UE, over a second plurality of resource blocks of a second sidelink feedback channel resource, a second feedback message associated with the one or more other sidelink data messages, wherein the second feedback message indicates a second plurality of feedback bits comprising one or more other feedback bits associated with the one or more other sidelink data messages, and wherein the second plurality of feedback bits comprises at least one feedback bit for each slot of the time period.

Clause 7: The method of any one of Clauses 1-6, wherein the set has a periodicity of the first number of slots.

Clause 8: The method of any one of Clauses 1-7, further comprising: receiving, from the second UE, for each of the one or more sidelink data messages, a corresponding sidelink control information indicating a corresponding offset value defining a duration between reception of the one or more sidelink data messages and transmission of the first feedback message, wherein the corresponding offset value is one of a number of defined offset values, and wherein the first number of slots is equal to the number of defined offset values.

Clause 9: A method wireless communications by a first UE, the method comprising: transmitting, to a second UE, one or more sidelink data messages over a first subchannel during a time period having a duration of a first number of slots that is greater than one; and receiving, from the second UE, over a plurality of resource blocks of a sidelink feedback channel resource of a first feedback channel occasion of a set of periodically occurring feedback channel occasions, a first feedback message associated with the one or more sidelink data messages, wherein the first feedback message indicates a plurality of feedback bits comprising one or more feedback bits associated with the one or more sidelink data messages, wherein the plurality of feedback bits further comprises a feedback bit that is not associated with any sidelink data message, and wherein the plurality of feedback bits comprises at least one feedback bit for each slot of the time period.

Clause 10: The method of Clause 9, wherein each of the plurality of feedback bits indicates a corresponding ACK or a corresponding NACK.

Clause 11: The method of Clause 10, wherein the feedback bit that is not associated with any sidelink data message indicates a NACK.

Clause 12: The method of any one of Clauses 9-11, wherein, for each slot of the time period, the corresponding at least one feedback bit of the plurality of feedback bits comprises multiple feedback bits corresponding to a plurality of spatial layers.

Clause 13: The method of any one of Clauses 9-12, further comprising: transmitting, to the second UE, one or more other sidelink data messages over a second subchannel during the time period; and receiving, from the second UE, over a second plurality of resource blocks of a second sidelink feedback channel resource, a second feedback message associated with the one or more other sidelink data messages, wherein the second feedback message indicates a second plurality of feedback bits comprising one or more other feedback bits associated with the one or more other sidelink data messages, and wherein the second plurality of feedback bits comprises at least one feedback bit for each slot of the time period.

Clause 14: The method of any one of Clauses 9-13, wherein the set has a periodicity of the first number of slots.

Clause 15: The method of any one of Clauses 9-14, further comprising: transmitting, to the second UE, for each of the one or more sidelink data messages, a corresponding sidelink control information indicating a corresponding offset value defining a duration between reception of the one or more sidelink data messages and transmission of the first feedback message, wherein the corresponding offset value is one of a number of defined offset values, and wherein the first number of slots is equal to the number of defined offset values.

Clause 16: A method wireless communications by a first UE, the method comprising: receiving, from a second UE, one or more sidelink data messages over a first subchannel or a first frequency interlace during a time period having a duration of a first number of slots that is greater than one; selecting a first sidelink feedback channel resource from a first plurality of sidelink feedback channel resources in a first resource pool based on at least one of a first identifier associated with the second UE or a groupcast identifier associated with the one or more sidelink data messages; and transmitting, to the second UE, over a plurality of resource blocks of the first sidelink feedback channel resource, a first feedback message associated with the one or more sidelink data messages, wherein the first feedback message indicates a plurality of feedback bits comprising one or more feedback bits associated with at least one of the one or more sidelink data messages.

Clause 17: The method of Clause 16, wherein the one or more sidelink data messages are received over the first frequency interlace, the first resource pool comprises a plurality of frequency interlace groups, each of the plurality of frequency interlace groups comprises a plurality of sidelink feedback channel resources, the plurality of frequency interlace groups comprise a first frequency interlace group comprising the first plurality of sidelink feedback channel resources, and the method further comprises selecting the first frequency interlace group based on the first frequency interlace.

Clause 18: The method of Clause 17, wherein the first frequency interlace group comprises the first frequency interlace.

Clause 19: The method of any one of Clauses 16-18, wherein the one or more sidelink data messages are received over the first subchannel, the first resource pool comprises a plurality of resource block groups, each of the plurality of resource block groups comprises a plurality of sidelink feedback channel resources, the plurality of resource block groups comprise a first resource block group comprising the first plurality of sidelink feedback channel resources, and the method further comprises: selecting the first resource block group based on the first subchannel.

Clause 20: The method of any one of Clauses 16-19, wherein the first resource pool includes only one resource block group or one frequency interlace group.

Clause 21: The method of any one of Clauses 16-20, further comprising: receiving, from the second UE, one or more other sidelink data messages, wherein the one or more sidelink data messages are one or more unicast sidelink data messages, and wherein the one or more other sidelink data messages are at least one of one or more groupcast sidelink data messages or one or more broadcast sidelink data messages; selecting a second sidelink feedback channel resource from the first resource pool; and transmitting, to the second UE, over a second plurality of resource blocks of the second sidelink feedback channel resource, a second feedback message associated with the one or more other sidelink data messages, wherein the second feedback message indicates a second plurality of feedback bits comprising one or more other feedback bits associated with at least one of the one or more other sidelink data messages.

Clause 22: The method of any one of Clauses 16-21, further comprising: receiving, from the second UE, one or more other sidelink data messages, wherein the one or more sidelink data messages are one or more unicast sidelink data messages, and wherein the one or more other sidelink data messages are at least one of one or more groupcast sidelink data messages or one or more broadcast sidelink data messages; selecting a second sidelink feedback channel resource from a second resource pool; and transmitting, to the second UE, a second feedback message associated with at least one of the one or more other sidelink data messages.

Clause 23: The method of Clause 22, wherein the sidelink feedback channel resources of the first resource pool are frequency division multiplexed with sidelink feedback channel resources of the second resource pool.

Clause 24: The method of Clause 22, wherein the sidelink feedback channel resources of the first resource pool are time division multiplexed with sidelink feedback channel resources of the second resource pool.

Clause 25: The method of Clause 22, wherein the second feedback message indicates a second plurality of feedback bits comprising one or more other feedback bits associated with at least one of the one or more other sidelink data messages.

Clause 26: The method of Clause 22, wherein the second feedback message indicates only a single-bit.

Clause 27: The method of any one of Clauses 16-26, further comprising: receiving, from the second UE, one or more other sidelink data messages, wherein the one or more sidelink data messages are one or more unicast sidelink data messages, wherein the one or more other sidelink data messages are at least one of one or more groupcast sidelink data messages or one or more broadcast sidelink data messages, wherein the first feedback message further indicates one or more other feedback bits associated with at least one of the one or more other sidelink data messages based on the one or more sidelink data messages and the one or more other sidelink data messages being associated with a same feedback channel occasion.

Clause 28: The method of Clause 27, wherein the first feedback message indicates feedback bits for less than all of the one or more sidelink data messages or the one or more other sidelink data messages.

Clause 29: The method of Clause 28, wherein which of the one or more sidelink data messages or the one or more other sidelink data messages do not have feedback bits indicated in the first feedback message is based on a priority of unicast sidelink data messages and a priority of groupcast or broadcast sidelink messages.

Clause 30: The method of Clause 28, wherein which of the one or more sidelink data messages or the one or more other sidelink data messages do not have feedback bits indicated in the first feedback message is based on a priority of each of the one or more sidelink data messages and the one or more other sidelink data messages.

Clause 31: A method wireless communications by a first UE, the method comprising: transmitting, to a second UE, one or more sidelink data messages over a first subchannel or a first frequency interlace during a time period having a duration of a first number of slots that is greater than one; and receiving, from the second UE, over a plurality of resource blocks of a first sidelink feedback channel resource of a first plurality of sidelink feedback channel resources in a first resource pool, wherein the first sidelink feedback channel resource is associated with at least one of a first identifier associated with the first UE or a groupcast identifier associated with the one or more sidelink data messages, a first feedback message associated with the one or more sidelink data messages, wherein the first feedback message indicates a plurality of feedback bits comprising one or more feedback bits associated with at least one of the one or more sidelink data messages.

Clause 32: The method of Clause 31, wherein the one or more sidelink data messages are transmitted over the first frequency interlace, the first resource pool comprises a plurality of frequency interlace groups, each of the plurality of frequency interlace groups comprises a plurality of sidelink feedback channel resources, the plurality of frequency interlace groups comprise a first frequency interlace group comprising the first plurality of sidelink feedback channel resources, and the first frequency interlace group is associated with the first frequency interlace.

Clause 33: The method of Clause 32, wherein the first frequency interlace group comprises the first frequency interlace.

Clause 34: The method of any one of Clauses 31-33, wherein the one or more sidelink data messages are received over the first subchannel, the first resource pool comprises a plurality of resource block groups, each of the plurality of resource block groups comprises a plurality of sidelink feedback channel resources, the plurality of resource block groups comprise a first resource block group comprising the first plurality of sidelink feedback channel resources, and the first resource block group is associated with the first subchannel.

Clause 35: The method of any one of Clauses 31-34, wherein the first resource pool includes only one resource block group or one frequency interlace group.

Clause 36: The method of any one of Clauses 31-35, further comprising: transmitting, to the second UE, one or more other sidelink data messages, wherein the one or more sidelink data messages are one or more unicast sidelink data messages, and wherein the one or more other sidelink data messages are at least one of one or more groupcast sidelink data messages or one or more broadcast sidelink data messages; and receiving, from the second UE, over a second plurality of resource blocks of a second sidelink feedback channel resource of the first resource pool, a second feedback message associated with the one or more other sidelink data messages, wherein the second feedback message indicates a second plurality of feedback bits comprising one or more feedback bits associated with at least one of the one or more other sidelink data messages.

Clause 37: The method of any one of Clauses 31-36, further comprising: transmitting, to the second UE, one or more other sidelink data messages, wherein the one or more sidelink data messages are one or more unicast sidelink data messages, and wherein the one or more other sidelink data messages are at least one of one or more groupcast sidelink data messages or one or more broadcast sidelink data messages; and receiving, from the second UE, a second feedback message associated with at least one of the one or more other sidelink data messages.

Clause 38: The method of Clause 37, wherein the sidelink feedback channel resources of the first resource pool are frequency division multiplexed with sidelink feedback channel resources of a second resource pool.

Clause 39: The method of Clause 37, wherein the sidelink feedback channel resources of the first resource pool are time division multiplexed with sidelink feedback channel resources of a second resource pool.

Clause 40: The method of Clause 37, wherein the second feedback message indicates a second plurality of feedback bits associated with at least one of the one or more other sidelink data messages.

Clause 41: The method of Clause 37, wherein the second feedback message indicates only a single-bit.

Clause 42: The method of any one of Clauses 31-41, further comprising: transmitting, to the second UE, one or more other sidelink data messages, wherein the one or more sidelink data messages are one or more unicast sidelink data messages, wherein the one or more other sidelink data messages are at least one of one or more groupcast sidelink data messages or one or more broadcast sidelink data messages, wherein the first feedback message further indicates one or more feedback bits associated with at least one of the one or more other sidelink data messages based on the one or more sidelink data messages and the one or more other sidelink data messages being associated with a same feedback channel occasion.

Clause 43: The method of Clause 42, wherein the first feedback message indicates feedback bits for less than all of the one or more sidelink data messages or the one or more other sidelink data messages.

Clause 44: The method of Clause 43, wherein which of the one or more sidelink data messages or the one or more other sidelink data messages do not have feedback bits indicated in the first feedback message is based on a priority of unicast sidelink data messages and a priority of groupcast or broadcast sidelink messages.

Clause 45: The method of Clause 43, wherein which of the one or more sidelink data messages or the one or more other sidelink data messages do not have feedback bits indicated in the first feedback message is based on a priority of each of the one or more sidelink data messages and the one or more other sidelink data messages.

Clause 46: A processing system, comprising: a memory comprising computer-executable instructions; one or more processors configured to execute the computer-executable instructions and cause the processing system to perform a method in accordance with any one of Clauses 1-45.

Clause 47: A processing system, comprising means for performing a method in accordance with any one of Clauses 1-45.

Clause 48: A non-transitory computer-readable medium comprising computer-executable instructions that, when executed by one or more processors of a processing system, cause the processing system to perform a method in accordance with any one of Clauses 1-45.

Clause 49: A computer program product embodied on a computer-readable storage medium comprising code for performing a method in accordance with any one of Clauses 1-45.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method for wireless communications by a first user equipment (UE), the method comprising:
receiving, from a second UE, one or more sidelink data messages over a first subchannel during a time period having a duration of a first number of slots that is greater than one; and
transmitting, to the second UE, over a plurality of resource blocks of a sidelink feedback channel resource of a first feedback channel occasion of a set of periodically occurring feedback channel occasions, a first feedback message associated with the one or more sidelink data messages,
wherein the first feedback message indicates a plurality of feedback bits comprising one or more feedback bits associated with the one or more sidelink data messages,
wherein the plurality of feedback bits further comprises a feedback bit that is not associated with any sidelink data message, and
wherein the plurality of feedback bits comprises at least one feedback bit for each slot of the time period.

2. The method of claim 1, wherein each of the plurality of feedback bits indicates a corresponding acknowledgement (ACK) or a corresponding negative ACK (NACK).

3. The method of claim 2, wherein the feedback bit that is not associated with any sidelink data message indicates a NACK.

4. The method of claim 1, further comprising:
receiving, from a third UE, one or more other sidelink data messages over the first subchannel during the time period; and
transmitting, to the third UE, over a second plurality of resource blocks of a second sidelink feedback channel resource, a second feedback message associated with the one or more other sidelink data messages,
wherein the second feedback message indicates a second plurality of feedback bits comprising one or more other feedback bits associated with the one or more other sidelink data messages, and
wherein the second plurality of feedback bits comprises at least one feedback bit for each slot of the time period.

5. The method of claim 1, wherein, for each slot of the time period, the corresponding at least one feedback bit of the plurality of feedback bits comprises multiple feedback bits corresponding to a plurality of spatial layers.

6. The method of claim 1, further comprising:
receiving, from the second UE, one or more other sidelink data messages over a second subchannel during the time period; and
transmitting, to the second UE, over a second plurality of resource blocks of a second sidelink feedback channel resource, a second feedback message associated with the one or more other sidelink data messages,
wherein the second feedback message indicates a second plurality of feedback bits comprising one or more other feedback bits associated with the one or more other sidelink data messages, and
wherein the second plurality of feedback bits comprises at least one feedback bit for each slot of the time period.

7. The method of claim 1, wherein the set has a periodicity of the first number of slots.

8. The method of claim 1, further comprising:
receiving, from the second UE, for each of the one or more sidelink data messages, a corresponding sidelink control information indicating a corresponding offset value defining a duration between reception of the one or more sidelink data messages and transmission of the first feedback message,
wherein the corresponding offset value is one of a number of defined offset values, and
wherein the first number of slots is equal to the number of defined offset values.

9. A method for wireless communications by a first user equipment (UE), the method comprising:
transmitting, to a second UE, one or more sidelink data messages over a first subchannel during a time period having a duration of a first number of slots that is greater than one; and
receiving, from the second UE, over a plurality of resource blocks of a sidelink feedback channel resource of a first feedback channel occasion of a set of periodically occurring feedback channel occasions, a first feedback message associated with the one or more sidelink data messages,
wherein the first feedback message indicates a plurality of feedback bits comprising one or more feedback bits associated with the one or more sidelink data messages,
wherein the plurality of feedback bits further comprises a feedback bit that is not associated with any sidelink data message, and
wherein the plurality of feedback bits comprises at least one feedback bit for each slot of the time period.

10. The method of claim 9, wherein each of the plurality of feedback bits indicates a corresponding acknowledgement (ACK) or a corresponding negative ACK (NACK).

11. The method of claim 10, wherein the feedback bit that is not associated with any sidelink data message indicates a NACK.

12. A method for wireless communications by a first user equipment (UE), the method comprising:
receiving, from a second UE, one or more sidelink data messages over a first subchannel or a first frequency interlace during a time period having a duration of a first number of slots that is greater than one;
selecting a first sidelink feedback channel resource from a first plurality of sidelink feedback channel resources in a first resource pool based on at least one of a first identifier associated with the second UE or a groupcast identifier associated with the one or more sidelink data messages; and
transmitting, to the second UE, over a plurality of resource blocks of the first sidelink feedback channel resource, a first feedback message associated with the one or more sidelink data messages,
wherein the first feedback message indicates a plurality of feedback bits comprising one or more feedback bits associated with at least one of the one or more sidelink data messages.

13. The method of claim 12, wherein:
the one or more sidelink data messages are received over the first frequency interlace,
the first resource pool comprises a plurality of frequency interlace groups,
each of the plurality of frequency interlace groups comprises a plurality of sidelink feedback channel resources,
the plurality of frequency interlace groups comprise a first frequency interlace group comprising the first plurality of sidelink feedback channel resources, and
the method further comprises selecting the first frequency interlace group based on the first frequency interlace.

14. The method of claim 13, wherein the first frequency interlace group comprises the first frequency interlace.

15. The method of claim 12, wherein:
the one or more sidelink data messages are received over the first subchannel,
the first resource pool comprises a plurality of resource block groups,
each of the plurality of resource block groups comprises a plurality of sidelink feedback channel resources,
the plurality of resource block groups comprise a first resource block group comprising the first plurality of sidelink feedback channel resources, and
the method further comprises: selecting the first resource block group based on the first subchannel.

16. The method of claim 12, wherein the first resource pool includes only one resource block group or one frequency interlace group.

17. The method of claim 12, further comprising:
receiving, from the second UE, one or more other sidelink data messages,
wherein the one or more sidelink data messages are one or more unicast sidelink data messages, and
wherein the one or more other sidelink data messages are at least one of one or more groupcast sidelink data messages or one or more broadcast sidelink data messages;
selecting a second sidelink feedback channel resource from the first resource pool; and
transmitting, to the second UE, over a second plurality of resource blocks of the second sidelink feedback channel resource, a second feedback message associated with the one or more other sidelink data messages,
wherein the second feedback message indicates a second plurality of feedback bits comprising one or more other feedback bits associated with at least one of the one or more other sidelink data messages.

18. The method of claim 12, further comprising:
receiving, from the second UE, one or more other sidelink data messages,
wherein the one or more sidelink data messages are one or more unicast sidelink data messages, and
wherein the one or more other sidelink data messages are at least one of one or more groupcast sidelink data messages or one or more broadcast sidelink data messages;
selecting a second sidelink feedback channel resource from a second resource pool; and
transmitting, to the second UE, a second feedback message associated with at least one of the one or more other sidelink data messages.

19. The method of claim 18, wherein sidelink feedback channel resources of the first resource pool are frequency division multiplexed with sidelink feedback channel resources of the second resource pool.

20. The method of claim 18, wherein sidelink feedback channel resources of the first resource pool are time division multiplexed with sidelink feedback channel resources of the second resource pool.

21. The method of claim 18, wherein the second feedback message indicates a second plurality of feedback bits comprising one or more other feedback bits associated with at least one of the one or more other sidelink data messages.

22. The method of claim 18, wherein the second feedback message indicates only a single-bit.

23. The method of claim 12, further comprising:
receiving, from the second UE, one or more other sidelink data messages,
wherein the one or more sidelink data messages are one or more unicast sidelink data messages,
wherein the one or more other sidelink data messages are at least one of one or more groupcast sidelink data messages or one or more broadcast sidelink data messages,
wherein the first feedback message further indicates one or more other feedback bits associated with at least one of the one or more other sidelink data messages based on the one or more sidelink data messages and the one or more other sidelink data messages being associated with a same feedback channel occasion.

24. The method of claim 23, wherein the first feedback message indicates feedback bits for less than all of the one or more sidelink data messages or the one or more other sidelink data messages.

25. The method of claim 24, wherein which of the one or more sidelink data messages or the one or more other sidelink data messages do not have feedback bits indicated in the first feedback message is based on a priority of unicast sidelink data messages and a priority of groupcast or broadcast sidelink messages.

26. The method of claim 24, wherein which of the one or more sidelink data messages or the one or more other sidelink data messages do not have feedback bits indicated in the first feedback message is based on a priority of each of the one or more sidelink data messages and the one or more other sidelink data messages.

27. A method for wireless communications by a first user equipment (UE), the method comprising:
transmitting, to a second UE, one or more sidelink data messages over a first subchannel or a first frequency interlace during a time period having a duration of a first number of slots that is greater than one; and
receiving, from the second UE, over a plurality of resource blocks of a first sidelink feedback channel resource of a first plurality of sidelink feedback channel resources in a first resource pool, wherein the first sidelink feedback channel resource is associated with at least one of a first identifier associated with the first UE or a groupcast identifier associated with the one or more sidelink data messages, a first feedback message associated with the one or more sidelink data messages,
wherein the first feedback message indicates a plurality of feedback bits comprising one or more feedback bits associated with at least one of the one or more sidelink data messages.

28. The method of claim 27, wherein:
the one or more sidelink data messages are transmitted over the first frequency interlace,
the first resource pool comprises a plurality of frequency interlace groups,
each of the plurality of frequency interlace groups comprises a plurality of sidelink feedback channel resources,
the plurality of frequency interlace groups comprise a first frequency interlace group comprising the first plurality of sidelink feedback channel resources, and
the first frequency interlace group is associated with the first frequency interlace.

29. The method of claim 28, wherein the first frequency interlace group comprises the first frequency interlace.

30. (canceled)
